(19) United States
(12) Patent Application Publication
(10) Pub. No.: US 2018/0269511 A1
(43) Pub. Date: Sep. 20, 2018

(54) MICROBIAL FUEL CELL AND MICROBIAL FUEL CELL SYSTEM

(71) Applicant: SHARP KABUSHIKI KAISHA, Sakai City, Osaka (JP)

(72) Inventors: MAKOTO TOGO, Sakai City, Osaka (JP); HIDEKAZU SHIMA, Sakai City, Osaka (JP)

(73) Assignee: SHARP KABUSHIKI KAISHA, Sakai City, Osaka (JP)

(21) Appl. No.: 15/757,459

(22) PCT Filed: Aug. 23, 2016
(86) PCT No.: PCT/JP2016/074560

§ 371 Date: Mar. 5, 2018

(30) Foreign Application Priority Data
Mar. 29, 2016 (JP) 2016-066711

(51) Int. Cl. H01M 8/16; H01M 8/04186; H01M 8/2455

(52) U.S. Cl. CPC H01M 8/16; H01M 8/2455; H01M 8/04186

(57) ABSTRACT

Provided is a microbial fuel cell which is capable of stably generating electricity and in which a pump or the like for fuel supply is not necessary and low oxygen concentration is maintained in the vicinity of a fuel electrode. A microbial fuel cell (1A) includes: a housing (2) that defines a closed space isolated from an external environment; and an ion-conductive layer (5) that divides the closed space into a fuel chamber (3) and an air chamber (4), the fuel chamber (3) being configured to have therein a microorganism-containing substance (10), the air chamber (4) containing oxygen therein. The housing (2) has, in at least part thereof, a hole (6) through which the external environment and the fuel chamber (3) are in communication with each other. The housing (2) is provided with an openable/closeable member (7) configured to be able to open and close the hole (6).

### TECHNICAL FIELD

The present invention relates to a microbial fuel cell and a system including a microbial fuel cell.

### BACKGROUND ART

Microbial fuel cells, which utilize the activity of anaerobic exoelectrogens, have been known. A microbial fuel cell is a cell that generates electricity in the following manner: electrons produced during organic matter decomposition by exoelectrogens are collected at a negative electrode; the electrons travel from the negative electrode to a positive electrode through an external circuit; H+ ions (protons) also produced during the organic matter decomposition by the exoelectrogens are transferred to the positive electrode; and the protons, oxygen, and the electrons react at the positive electrode.

An example of such a microbial fuel cell is a microbial fuel cell disclosed in Patent Literature 1. The microbial fuel cell disclosed in Patent Literature 1 is configured such that: an anode and an air cathode are disposed within a casing; and a fuel solution is continuously fed into the casing.

Patent Literature 2 discloses a microbial fuel cell configured such that: a plurality of cylindrical positive electrode materials are disposed in a casing; each of the cylindrical positive electrode materials is covered with an ion-conductive film; a negative electrode material is filled in the casing so as to fill the gaps between a plurality of cylinders constituted by the cylindrical positive electrode materials covered with the ion-conductive films; and a fuel solution is passed through the negative electrode material.

### CITATION LIST

### Patent Literature

### [Patent Literature 1]

Japanese Patent Application Publication, Tokukai, No. 2015-95274 (publication date: May 18, 2015)

### [Patent Literature 2]

Japanese Patent Application Publication, Tokukai, No. 2011-65875 (publication date: Mar. 31, 2011)

### [Patent Literature 3]

Japanese Patent Application Publication, Tokukai, No. 2013-84541 (publication date: May 9, 2013)

### [Patent Literature 4]

Japanese Patent Application Publication, Tokukai, No. 2015-210968 (publication date: Nov. 24, 2015)

### SUMMARY OF INVENTION

### Technical Problem

However, the techniques disclosed in Patent Literatures 1 and 2 necessitate continuous supply of a fuel solution and thus necessitate a pump mechanism to send the fuel solution. Therefore, the techniques disclosed in Patent Literatures 1 and 2 have an issue in that energy is used to drive the pump and have a disadvantage in that the techniques have only limited use.

Furthermore, in the vicinity of the negative electrode (fuel electrode) where the anaerobic exoelectrogens are used, it is necessary to maintain low oxygen concentration. Therefore, in a case where continuous supply of a fuel solution is to be carried out, it is necessary that a fuel solution having low oxygen concentration be continuously supplied to the vicinity of the fuel electrode. This has led to the necessity for a process of preparing a fuel solution having low oxygen concentration.

On the other hand, a microbial fuel cell which does not necessitate constant supply of a fuel solution is also known. Such a microbial fuel cell may not require any pump mechanism, but will run out of fuel and end up stopping generating electricity in the long run.

An embodiment of the present invention was made in view of the above conventional issues, and it is an object of an embodiment of the present invention to provide a microbial fuel cell which is capable of stably generating electricity and in which a pump or the like for fuel supply is not necessary and low oxygen concentration is maintained in the vicinity of a fuel electrode.

### Solution to Problem

In order to attain the above object, a microbial fuel cell of one aspect of the present invention includes: a housing that defines a closed space isolated from an external environment; an electrolyte layer with proton conductivity, the electrolyte layer dividing the closed space into a fuel chamber and an air chamber, the fuel chamber being configured to have therein a microorganism-containing substance containing an exoelectrogen, an aerobic bacterium, and a fuel substance, the air chamber having oxygen therein; a negative electrode that is disposed in the fuel chamber and that is configured to receive an electron produced by decomposition, by the exoelectrogen, of organic matter in the fuel substance; and a positive electrode that is disposed in the air chamber so as to be in contact with the electrolyte layer and that is configured to donate an electron to oxygen, the housing having, in at least part thereof, a hole through which the external environment and the fuel chamber are in communication with each other, the housing being provided with an openable/closeable member configured to be able to open and close the hole.

### Advantageous Effects of Invention

One aspect of the present invention brings about the following effect: a microbial fuel cell is provided which is capable of stably generating electricity and in which a pump or the like for fuel supply is not necessary and low oxygen concentration is maintained in the vicinity of a fuel electrode.

### BRIEF DESCRIPTION OF DRAWINGS

FIG. 1 is a longitudinal cross-sectional view schematically illustrating a configuration of a microbial fuel cell of Embodiment 1 of the present invention.

FIG. 2 is a longitudinal cross-sectional view schematically illustrating an example configuration of an openable/closeable member of the microbial fuel cell.

FIG. 3 is a timing diagram schematically illustrating: open and closed states of the openable/closeable member of the microbial fuel cell; points in time at which fuel is introduced; and points in time at which operation of feeding electricity from the microbial fuel cell to a load is carried out.

FIG. 4 schematically illustrates metabolism by each bacterium in the vicinity of an anode of the microbial fuel cell.

FIG. 5 is a longitudinal cross-sectional view schematically illustrating a configuration of a microbial fuel cell of Embodiment 2 of the present invention.

FIG. 6 is a longitudinal cross-sectional view schematically illustrating a configuration of a microbial fuel cell of Embodiment 3 of the present invention.

FIG. 7 is a longitudinal cross-sectional view schematically illustrating a configuration of a microbial fuel cell of Embodiment 4 of the present invention.

FIG. 8 is a longitudinal cross-sectional view schematically illustrating a configuration of a microbial fuel cell of Embodiment 5 of the present invention.

FIG. 9 is a longitudinal cross-sectional view schematically illustrating a configuration of a microbial fuel cell of Embodiment 6 of the present invention.

FIG. 10 is a longitudinal cross-sectional view schematically illustrating a configuration of a microbial fuel cell of Embodiment 7 of the present invention.

FIG. 11 is a longitudinal cross-sectional view schematically illustrating a configuration of a microbial fuel cell of Embodiment 8 of the present invention.

FIG. 12 is a longitudinal cross-sectional view schematically illustrating a configuration of a microbial fuel cell of Embodiment 9 of the present invention.

FIG. 13 is a longitudinal cross-sectional view schematically illustrating a configuration of a microbial fuel cell system of Embodiment 10 of the present invention.

FIG. 14 is a longitudinal cross-sectional view schematically illustrating a configuration of a microbial fuel cell system of Embodiment 11 of the present invention.

FIG. 15 is a longitudinal cross-sectional view schematically illustrating a configuration of a microbial fuel cell of Embodiment 12 of the present invention.

FIG. 16 schematically illustrates a microbial fuel cell system of Embodiment 12 of the present invention.

FIG. 17 is a graph schematically illustrating how output voltage changes when each microbial fuel cell of the microbial fuel cell system operates.

FIG. 18 is a graph illustrating another example of how output voltage changes when each microbial fuel cell of the microbial fuel cell system operates.

FIG. 19 schematically illustrates a microbial fuel cell system of Embodiment 13 of the present invention.

FIG. 20 illustrates example configurations of microbial fuel cell units of the microbial fuel cell system.

FIG. 21 schematically illustrates a microbial fuel cell system of Embodiment 14 of the present invention.

FIG. 22 is a longitudinal cross-sectional view schematically illustrating a configuration of a microbial fuel cell system of Embodiment 15 of the present invention.

FIG. 23 schematically illustrates a microbial fuel cell system of Embodiment 16 of the present invention.

FIG. 24 schematically illustrates another example of the microbial fuel cell system.

FIG. 25 is a longitudinal cross-sectional view schematically illustrating a configuration of the microbial fuel cell system.

(a) and (b) of FIG. 26 show graphs schematically illustrating how output voltage changes at points in time in which a microbial fuel cell and a solar cell operate when the microbial fuel cell system is in an electricity generating mode.

### DESCRIPTION OF EMBODIMENTS

In this specification, the vertical direction in each drawing is assumed to be parallel to the gravitational direction, for convenience of description. The following description is based on the assumption that “up” means up along the gravitational direction whereas “side” means horizontal to the gravitational force.

### Embodiment 1

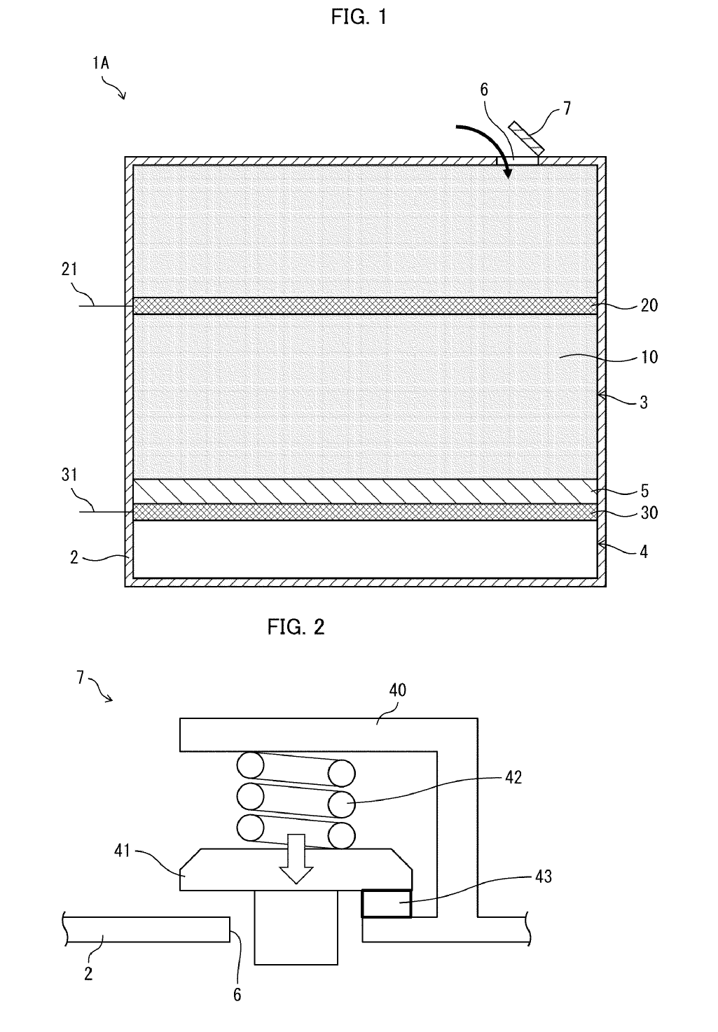

The following description will discuss one embodiment of the present invention with reference to FIGS. 1 to 4.

A microbial fuel cell 1A of Embodiment 1 is described with reference to FIG. 1. FIG. 1 is a longitudinal cross-sectional view schematically illustrating a configuration of the microbial fuel cell 1A of Embodiment 1.

As illustrated in FIG. 1, the microbial fuel cell 1A of Embodiment 1 includes: a housing 2; an ion-conductive layer (electrolyte layer) 5 that divides the internal space of the housing 2 into a fuel chamber 3 and an air chamber 4; a microorganism-containing substance 10 and an anode 20 disposed inside the fuel chamber 3; and a cathode 30 disposed inside the air chamber 4. The housing 2 has a hole 6 in its top wall, and the hole 6 is provided with an openable/closeable member 7. The ion-conductive layer 5, the anode 20, and the cathode 30 are each provided substantially horizontally so as to span the entire distance between two opposite wall faces of the housing 2.

The microbial fuel cell 1A also has an anode wire 21 electrically connected to the anode 20 and a cathode wire 31 electrically connected to the cathode 30. The anode wire 21 and the cathode wire 31 each pass through the housing 2 and extend to outside of the housing 2.

In the housing 2, the following members are arranged in the order named from bottom: the air chamber 4, the cathode 30, the ion-conductive layer 5, the fuel chamber 3, and the hole 6. The anode 20 is positioned substantially in the middle of the fuel chamber 3. The cathode 30 and the ion-conductive layer 5 are in close contact with each other.

The way in which the members are arranged inside the housing 2 is not particularly limited, provided that the ion-conductive layer 5 is present between the anode 20 and the cathode 30. For instance, the anode 20 and the ion-conductive layer 5 may be in contact with each other. The microbial fuel cell 1A may be configured such that the air chamber 4, the cathode 30, the ion-conductive layer 5, and the anode 20 are arranged in this order from above, or may be configured such that these members are arranged in this order from left to right.

In general, the microbial fuel cell 1A is a cell like that described below. The fuel chamber 3 has therein the microorganism-containing substance 10, which contains an exoelectrogen 11 and a fuel substance 12, in a manner such that the microorganism-containing substance 10 and the anode 20 are in contact with each other. The exoelectrogen 11 is capable of donating electrons to the anode 20. The air chamber 4 has at least oxygen therein, and the cathode 30 is exposed to air in the air chamber 4. The ion-conductive layer 5 has a function of allowing protons to travel from the anode 20 to the cathode 30.

According to such a microbial fuel cell 1A, when the anode wire 21 and the cathode wire 31 are in electrical connection with each other, a microbial fuel cell reaction (described later) occurs, thereby generating an electromotive force of the microbial fuel cell 1A. That is, the microbial fuel cell 1A generates electricity.

The following description will discuss each member of the microbial fuel cell 1A of Embodiment 1.

(Housing)

The housing 2 defines a closed space isolated from its external environment, and has a substantially square cross section when viewed from side. Although the housing 2 of Embodiment 1 has such a shape, the shape of the housing 2 is not particularly limited, provided that the housing 2 has a space therein. For example, the housing 2 may have a shape of a rectangular parallelepiped, a cylinder, or a sphere, or may have a shape other than those listed above.

Examples of the external environment include, but are not limited to, water, air, and soil.

The material for the housing 2 is not limited to a particular kind. The housing 2 is preferably made of a material that prevents current flow between the anode 20 and the cathode 30. The housing 2 is preferably made of an insulator or an insulated material.

Specific examples of the material for the housing 2 include generally used resin (or rubber) materials, fluorine-based resin (or rubber) materials, metal materials with insulation coating, and ceramic materials. Of these, the material for the housing 2 is desirably a fluorine-based resin (or rubber) material because of its low cost and high corrosion resistance.

Alternatively, the housing 2 may be made of a material having biodegradability, such as a cellulose-based polymer material. In a case where the housing 2 is made of such a biodegradable material, it is not necessary to collect unneeded microbial fuel cells 1A, and the microbial fuel cell 1A can be used as a disposable cell.

(Fuel Chamber)

The fuel chamber 3 is a space for containing the microorganism-containing substance 10 therein. The fuel chamber 3 includes the anode 20.

The housing 2 has, in a portion thereof which constitutes the top wall of the housing 2, a hole 6 through which the external environment outside the housing 2 and the fuel chamber 3 are in communication with each other. The hole 6 allows the microorganism-containing substance 10 to be supplied into the fuel chamber 3 from outside. The hole 6 is provided with the openable/closeable member 7 configured to be able to open and close the hole 6. The hole 6 and the openable/closeable member 7 will be described later in detail.

The fuel chamber 3 may have an air escape mechanism (not illustrated) in addition to the hole 6. For instance, in a case where the microbial fuel cell 1A is submerged in a fuel solution containing the microorganism-containing substance 10, air escape form the fuel chamber 3 through the air escape mechanism will help the microorganism-containing substance 10 easily flow into the fuel chamber 3 through the hole 6.

The fuel chamber 3 of Embodiment 1 is filled with the microorganism-containing substance 10 without gaps. The microbial fuel cell 1A may be configured such that the microorganism-containing substance 10 is contained in the fuel chamber 3 with some gaps. For the microbial fuel cell 1A to generate electricity, it is only necessary that the microorganism-containing substance 10 and the anode 20 be in contact with each other.

A microbial fuel cell in which the fuel chamber 3 has no microorganism-containing substance 10 therein and in which no microbial fuel cell reaction is occurring is also regarded as a microbial fuel cell of one aspect of the present invention. A microbial fuel cell 1A in this state is relatively lightweight, and therefore is convenient for transportation or the like thereof.

The microorganism-containing substance 10, which is to be disposed in the fuel chamber 3, contains: the exoelectrogen 11; and the fuel substance 12 which is for use in bacterial metabolism.

The microorganism-containing substance 10 is desirably soil that is rich in anaerobic exoelectrogen 11, and is desirably, for example, leaf mold. Alternatively, the microorganism-containing substance 10 may have high moisture content, that is, may be in the form of mud. The microorganism-containing substance 10 may be dirty water or waste water.

The exoelectrogen 11 contained in the microorganism-containing substance 10 may be selected appropriately from known anaerobic exoelectrogens such as Shewanella species, Geobacter species, Rhodoferax ferrireducens, and Desulfobulbus propionicus. Of these, Shewanella species are suitable as the exoelectrogen 11, because Shewanella species are contained in many kinds of soil in abundance and relatively easily donate electrodes to the anode 20. One or more kinds of exoelectrogen may be contained as the exoelectrogen 11 in the microorganism-containing substance 10.

The following arrangement may be employed: the microorganism-containing substance 10 contains an electron transfer agent (mediator) having an oxidized or reduced state and having cell membrane permeability; and the mediator collects electrons from the exoelectrogen 11 and supplies the electrons to the anode 20.

The fuel substance 12 contains at least organic matter OM and water (H₂O) for use in metabolism by the exoelectrogen 11. In a case where the microorganism-containing substance 10 contains some other microorganism in addition to the exoelectrogen 11, the fuel substance 12 may also contain a substance(s) for use in metabolism by such other microorganism. The organic matter OM is preferably, for example: a hydrocarbon such as glucose, acetic acid, and lactic acid; or an amino acid or the like. The organic matter OM may be constituted by one or more kinds of organic matter.

In the microorganism-containing substance 10, the exoelectrogen 11 decomposes and oxidizes the organic matter OM by its metabolism, and produces electrons and protons. The electrons are donated to the anode 20. The protons pass through the microorganism-containing substance 10 and the ion-conductive layer 5 and move to the cathode 30.

(Anode)

The anode 20 has a portion that is in contact with the microorganism-containing substance 10. The exoelectrogen 11 resides on this portion. This exoelectrogen 11 donates electrons to the anode 20.

Such an anode 20 is not limited, provided that it is made of an electrically conducive, highly corrosion-resistant material. Examples of such a material include: materials such as stainless steel, platinum, gold, carbon, nickel, titanium; and conductive materials (e.g., metals) coated with stainless steel, platinum, gold, carbon, nickel, titanium, or the like.

Alternatively, carbon felt, carbon paper, or the like may be used as a material for the anode 20. This makes it possible to reduce electric resistance, and also possible to increase the adsorbed amount of microorganisms. In addition, using such materials makes it possible to reduce production cost for the anode 20 as compared with the case of using a noble metal material.

The anode 20 preferably has a structure or a shape that makes the electrode area larger than the projected area, such as a fine structure or a meshed structure. Such an anode 20 provides a large area for adsorption of microorganisms, and thus makes it possible to obtain a large electric current. The anode 20 of Embodiment 1 is provided substantially horizontally so as to span the entire distance between two opposite wall faces of the housing 2.

It should be noted that the material that constitutes the anode 20, the shape of the anode 20, and the like are not limited to those described above.

Meanwhile, the following method is known in recent years: a method of improving efficiency of a microbial fuel cell by using an enzyme or microorganism as an electrode catalyst. The anode 20 may be coated with a medium containing an enzyme or microorganism in accordance with this method.

The anode 20 is electrically connected with the anode wire 21 that passes through the housing 2. Through the anode wire 21, electricity obtained from microbiological electric generation can be drawn from the cell.

The material for the anode wire 21 is desirably SUS (stainless steel), titanium, nickel, carbon, or the like which are highly corrosion-resistant materials, and these materials are desirably covered with an insulating resin or the like.

(Ion-Conductive Layer)

The microbial fuel cell 1A is configured such that, as described earlier, the ion-conductive layer 5 serving as an electrolyte layer is present between the anode 20 and the cathode 30.

The ion-conductive layer 5 is a layer that restricts the diffusion of oxygen from the air chamber 4 to the fuel chamber 3 where the anode 20 is situated and that allows ions to travel from the fuel chamber 3 to the air chamber 4. The ions include at least protons.

The “layer” as in the “ion-conductive layer 5” refers to, for example, a layer that includes a plane perpendicular to the vertical direction of the housing 2 of the microbial fuel cell 1A and that spreads over the entire area of the internal space of the housing 2 in that plane. In other words, the ion-conductive layer 5 is provided so as to partition the fuel chamber 3 and the air chamber 4 from each other, so that no gap is formed between the fuel chamber 3 and the air chamber 4.

The ion-conductive layer 5 is not particularly limited, provided that the ion-conductive layer 5 can conduct protons from the fuel chamber 3 to the air chamber 4 but prevent the diffusion and penetration of oxygen from the air chamber 4 to the fuel chamber 3. The ion-conductive layer 5 may be, for example, a solid electrolyte or an ion-conductive membrane containing an electrolyte. Alternatively, the ion-conductive layer 5 may be constituted by an electrolyte solution and ion-conductive films sandwiching the electrolyte solution therebetween. The ion-conductive layer 5 may be made up of one or more substances to achieve appropriate ion conductivity and/or oxygen permeability. In this case, the ion-conductive layer may have respective different substances on its fuel chamber 3-side and air chamber 4-side.

The ion-conductive layer 5 can be obtained by, for example, mixing a salt such as potassium chloride or sodium chloride into agar. Alternatively, the ion-conductive layer 5 can be, for example, Nafion (registered trademark) manufactured by Du Pont.

The ion-conductive layer 5 is preferably in the form of a hydrogel for its low cost, its ability to densely block oxygen, and its physical properties that can be easily adjusted by adjusting salinity and density.

When a hydrogel, which is constituted by a polymer material serving as a base and a large amount of moisture held in the polymer material, is disposed between the air chamber 4 and the fuel chamber 3, the hydrogel physically blocks oxygen ingress and diffusion from the air chamber 4 and prevents oxygen from reaching the anode 20. The hydrogel is also excellent in proton conductivity. Therefore, it is possible to make a microbial fuel cell 1A without impairing its internal resistance.

In addition, oxygen permeability, ionic conductivity, and flexibility of the hydrogel can be adjusted by adjusting the polymer structure, polymer material, moisture content, ionic strength, or the like of the hydrogel. Thus, using a hydrogel as the ion ion-conductive layer 5 allows for greater freedom in designing the microbial fuel cell 1A.

(Air Chamber)

The air chamber 4, in which the cathode 30 is situated, has at least oxygen therein. The air chamber 4 may have atmospheric air or pure oxygen therein, and the oxygen concentration in the air chamber 4 may be adjusted if needed.

The air chamber 4 is defined by the housing 2 and the ion-conductive layer 5, and is isolated from the external environment. In this case, since the oxygen in the air chamber 4 is consumed by the reaction at the cathode 30, the oxygen concentration in the air chamber 4 decreases with time as the electricity generation by the microbial fuel cell 1A proceeds.

Alternatively, the housing 2 may have fine air holes in its wall portion that defines the air chamber 4. The fine air holes allow air to be exchanged with that in the external environment. This makes it possible to maintain the oxygen concentration in the air chamber 4 at the same level as that in the external environment.

(Cathode)

The cathode 30 is configured to reduce oxygen in the air chamber 4 by using electrons coming through the cathode wire 31 and protons supplied through the ion conductive layer 5. Such a cathode 30 is made of a material that is electrically conductive, is highly corrosion-resistant, and has electrochemically oxygen-reducing ability. Examples of such a material include: materials such as stainless steel, platinum, gold, carbon, nickel, and titanium; and conductive materials (such as metals) coated with stainless steel, platinum, gold, carbon, nickel, titanium, or the like. Alternatively, the cathode 30 may be made of a conductive material coated with an enzyme or microorganism having an oxygen-reducing ability.

Alternatively, carbon felt, carbon paper, or the like may be used as a material for the cathode 30. This makes it possible to reduce electric resistance, and also possible to increase the electrode area that is capable of reducing oxygen. In addition, using such a material makes it possible to reduce cost as compared with the case of using a noble metal material.

Furthermore, use of a cathode 30 structured or shaped such that the electrode area is larger than the projected area, such as having a fine structure or a meshed structure, increases the area of reaction with oxygen, and thus makes it possible to have a large electric current generated.

The cathode 30 may have an electron mediator substance (electron mediator), such as ferrocyanide ion, around thereof or fixed thereto. With this, oxygen can be smoothly reduced at the electrode and current is also increased. Note, however, that such an electrode mediator substance is not essential.

It should be noted that the material that constitutes the cathode 30, the shape of the cathode 30, and the like are not limited to those described above.

The cathode 30 is electrically connected with the cathode wire 31, which passes through the housing 2. Through the cathode wire 31, electrons can be transferred from outside of the housing 2 to the cathode 30.

The material for the cathode wire 31 is desirably SUS (stainless steel), titanium, nickel, carbon, or the like which are highly corrosion-resistant materials, and these materials are desirably covered with an insulating resin or the like.

The above descriptions discussed a schematic configuration of the microbial fuel cell 1A. The following description will discuss drawbacks of a typical microbial fuel cell and characteristic features of the microbial fuel cell 1A of Embodiment 1.

Typical microbial fuel cells have the following drawback: since the presence of oxygen in the vicinity of the anode as the fuel electrode causes a decrease in performance, the conventional techniques described in Patent Literature 1 and 2 necessitate lowering of the oxygen concentration of an organic matter-containing solution by deaeration such as bubbling before passing the organic matter-containing solution. This necessitates a step of preparing an organic matter-containing solution with a low oxygen concentration and also necessitates a pump mechanism for sending the solution. That is, these techniques use energy to generate energy.

In addition, in a case where such microbial fuel cells are disposed in the same fuel solution and are connected in series, a short circuit may occur between electrodes and may hinder series connection, because the cells are not individually separated. That is, when a plurality of electrodes are in the same ion-conductive solution, electrodes may be short-circuited. This will be specifically described as follows.

Consider, for example, a case where two cells of a typical microbial fuel battery, which are not individually separated, are connected in series within the same solution. In this case, the positive electrode of the first cell, the negative electrode of the first cell, the positive electrode of the second cell, and the negative electrode of the second cell are connected in series. In this case, the negative electrode of the first cell and the positive electrode of the second cell, which are intermediate electrodes, are short-circuited within the same solution, so that the voltage that can be drawn from the battery is only the voltage of one cell that is made up of the positive electrode of the first cell and the negative electrode of the second cell.

Therefore, two cells cannot be connected in series within the same solution. In order to connect two cells in series, it is necessary to separate the solution for the first cell and the solution for the second cell from each other at least in terms of ion conduction.

Similarly, in a case where a sensor to electrochemically sense the fuel solution or the like is provided in the vicinity of the microbial fuel cell, the short circuit between electrodes may reduce the accuracy of the sensing.

On the other hand, a microbial fuel cell that does not require constant supply of a fuel solution does not necessitate a pump mechanism. It is possible to cause this microbial fuel cell to generate electricity by keeping a sufficient amount of the fuel solution around the fuel electrode. However, this microbial fuel cell has an issue in that it will run out of fuel and end up stopping generating electricity in the long run. In addition, also in this case, the fuel solution to be supplied needs to be adjusted in advance to have a low oxygen concentration.

In contrast, the microbial fuel cell 1A of Embodiment 1 includes the following main constituents. Specifically, the microbial fuel cell 1A of Embodiment 1 is configured such that: the housing 2 has the hole 6; the hole 6 is provided with the openable/closeable member 7; and the microorganism-containing substance 10 further contains at least an aerobic bacterium 13.

The following will discuss these constituents in detail.

(Hole and Openable/Closeable Member)

In the microbial fuel cell 1A of Embodiment 1, the housing 2 has the hole 6 in its portion that constitutes the top wall of the fuel chamber 3. The hole 6 allows the external environment outside the housing 2 and the fuel chamber 3 to communicate with each other. The position of the hole 6 is not particularly limited, provided that the hole 6 is in a wall of the fuel chamber 3. The hole 6 may be situated in a side wall of the housing 2. The size of the hole 6 is not particularly limited. For instance, the entire top wall of the housing 2 may constitute the hole 6.

The hole 6 allows sufficient supply of the microorganism-containing substance 10 into the fuel chamber 3. In a case where the microorganism-containing substance 10 has decreased in amount because of electricity generation by the microbial fuel cell 1A, an additional microorganism-containing substance 10 can be supplied through the hole 6. It is also possible to replace the microorganism-containing substance 10 with a fresh microorganism-containing substance 10 through the hole 6.

The hole 6 is provided with the openable/closeable member 7, which is configured to be able to open and close the hole 6. Provided that the openable/closeable member 7 in a closed state is configured to hermetically close the hole 6 to prevent the movement of moisture and oxygen between the external environment outside the housing 2 and the fuel chamber 3, the mechanism of the hermetic closing is not limited to a particular kind. For instance, the openable/closeable member 7 may be realized by a cap made of a gasket material that is detachably attached and that is capable of hermetic closing. A mechanism of pressing the gasket material against the hole 6 may be, for example, (i) a mechanism in which the hole 6 has a threaded groove and the openable/closeable member 7 serves as a thread, (ii) a mechanism in which the hole 6 and the openable/closeable member 7 are hinged together to form a single-swing openable/closeable member 7, or (iii) a mechanism in which the openable/closeable member 7 is slidable relative to the hole 6. Alternatively, the openable/closeable member 7 may be a cock mechanism configured such that the open and closed states of the hole 6 can be switched over by rotating a valve.

Alternatively, the openable/closeable member 7 may be configured such that, for instance, when the microbial fuel cell 1A is submerged in the fuel solution containing the microorganism-containing substance 10, the openable/closeable member 7 is brought into the closed state by the pressure inside the fuel solution.

Alternatively, the openable/closeable member 7 may be configured such that, in a case where the internal pressure of the fuel chamber 3 has exceeded a predetermined value when the openable/closeable member 7 is in the closed state, the openable/closeable member 7 is temporarily brought to the open state so that gas inside the fuel chamber 3 is released into the external environment.

An example configuration of the openable/closeable member 7 is described with reference to FIG. 2. FIG. 2 is a longitudinal cross-sectional view schematically illustrating an example configuration of the openable/closeable member 7 of the microbial fuel cell 1A of Embodiment 1. Such an openable/closeable member 7 can be suitably used mainly in a case where the external environment is a liquid such as water.

As illustrated in FIG. 2, the openable/closeable member 7 is constituted by: a base portion 40 joined to the housing 2; a cap member 41; an elastic member 42 that presses the cap member 41 against the hole 6; and a spacer 43 serving as a supporting member provided between the cap member 41 and the hole 6. These constituents are provided in the vicinity of the hole 6. The base portion 40 is a portion that is joined to and protruding from the housing 2, and that is in a letter-L shape bent at a right angle at a certain height from the housing 2.

When the cap member 41 is in close contact with the hole 6, the hole 6 is hermetically closed; however, when the spacer 43 is present, the spacer 43 makes a gap between the cap member 41 and the hole 6. In this condition, the openable/closeable member 7 is in the open state, and thus the hole 6 allows entrance of substances from the external environment into the fuel chamber 3 through the hole 6. That is, the spacer 43 keeps the openable/closeable member 7 in the open state.

The spacer 43 may be structured so as to be removed by an external operation. In the absence of the spacer 43, the cap member 41 is pressed against the housing 2 by the elastic member 42 and thereby the hole 6 is hermetically closed.

Alternatively, the spacer 43 may be made of a material that can be decomposed or dissolved by the external environment. For instance, the spacer 43 may be configured such that: the spacer 43 is made of a water-soluble material; and, in a case where the housing 2 is soaked in a moisture-containing external environment, substances of the external environment enter the fuel chamber 3 and thereafter the spacer 43 dissolves with a time delay, resulting in hermetic closing of the hole 6.

(Behavior of Openable/Closeable Member)

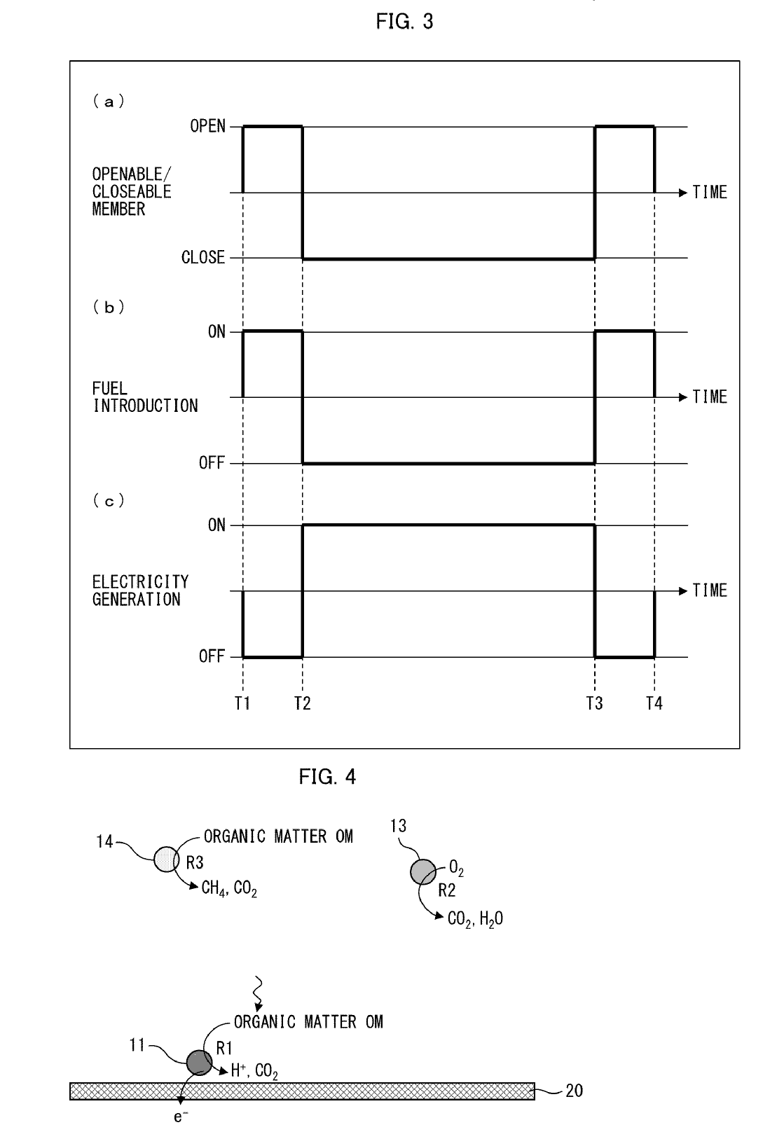

The following will discuss a behavior of the openable/closeable member 7 with reference to FIG. 3. FIG. 3 is a timing diagram schematically illustrating: open and closed states of the openable/closeable member 7 of the microbial fuel cell 1A; points in time at which fuel is introduced; and points in time at which operation of feeding electricity from the microbial fuel cell 1A to a load is carried out. The above fuel refers to the microorganism-containing substance 10.

The openable/closeable member 7 is in the open state while the fuel is introduced (from time Ti to time T2) and is in the closed state during electricity generation (from time T2 to time T3). After that, the openable/closeable member 7 is in the open state while the fuel is introduced again (from time T3 to time T4). It should be noted that the openable/closeable member 7 may be temporarily in the closed state while the fuel is being introduced, or may be temporarily in the open state during electricity generation. That is, the openable/closeable member 7 is brought to the closed state at least temporarily during electricity generation.

Since the openable/closeable member 7 is in the closed state after the fuel has been introduced like above, the fuel chamber 3, which serves as a fuel tank containing the microorganism-containing substance 10 therein, is hermetically closed.

With the hole 6 and the openable/closeable member as described above, it is possible to supply the microorganism-containing substance 10 to the fuel chamber 3 and also possible to achieve hermetic closing, thereby making it possible to prevent entrance of oxygen from the external environment. This can eliminate the need for a pump mechanism, and makes it possible to generate electricity in the long run without running out of fuel.

The above-described configuration does not imply any limitation. The microbial fuel cell 1A may have a plurality of holes 6, and the plurality of holes 6 may be provided with respective openable/closeable members 7.

It is noted here that, in order to enhance the function of the exoelectrogen 11 and increase the efficiency of the microbial fuel cell 1A, it is necessary to lower the oxygen concentration in the fuel chamber 3, as described earlier. In view of this, the microorganism-containing substance 10 of the microbial fuel cell 1A of Embodiment 1 further contains at least the aerobic bacterium 13 in addition to the exoelectrogen 11 and the fuel substance 12.

It is preferable that the microorganism-containing substance 10 further contains, in addition to the aerobic bacterium 13, an anaerobic bacterium 14 which is an anaerobic bacterium different than the exoelectrogen 11. In a case where the microorganism-containing substance 10 contains any of these bacteria, the fuel substance 12 contains a substance(s) necessary for metabolism by the aerobic bacterium 13 and/or the anaerobic bacterium 14.

(Aerobic Bacterium)

The aerobic bacterium 13 may be, for example, a lactic bacterium, yeast, Bacillus natto, or the like, and may be selected appropriately from conventionally known, appropriate aerobic bacteria. The aerobic bacterium 13 consumes oxygen and produces carbon dioxide through its metabolism to thereby raise the carbon dioxide partial pressure in the fuel chamber 3.

This makes it possible to lower the oxygen concentration in the microorganism-containing substance 10, and thus possible to create an environment suitable for the anaerobic exoelectrogen 11. This enhances the activity of the exoelectrogen 11 and increases the electric-generating capacity of the microbial fuel cell 1A.

The microorganism-containing substance 10 may contain one or more kinds of aerobic bacteria as the aerobic bacterium 13.

(Anaerobic Bacterium)

The anaerobic bacterium 14 is not limited, provided that the anaerobic bacterium 14 is a bacterium that consumes oxygen through its metabolism or that produces a gas different than oxygen through its metabolism. The anaerobic bacterium 14 can be, for example, an anaerobic bacterium that carries out alcoholic fermentation, methane fermentation, hydrogen fermentation, or the like.

The anaerobic bacterium 14 can be, for example, a methanogen. The methanogen produces methane and carbon dioxide through its metabolism using, for example, hydrogen, formic acid, acetic acid, 2-propanol, 2-butanol, a methylamine, methanol, and/or the like.

In a case where such a methanogen is contained, it is only necessary that the fuel substance 12 contain the above substrate(s) which can be used by the methanogen. With this, the methanogen produces methane and carbon dioxide and thereby lowers the oxygen concentration in the microorganism-containing substance 10 to a greater extent.

Also in a case of an anaerobic bacterium 14 of other kind than the methanogen, it is also possible to lower, with the produced gas, the oxygen concentration in the microorganism-containing substance 10.

In a case where, for instance, a substance produced through metabolism by the aerobic bacterium 13 or the anaerobic bacterium 14 is an organic matter OM that can be used by the exoelectrogen 11, the efficiency of the microbial fuel cell increases. For instance, in a case where the microorganism-containing substance 10 contains a lactic bacterium, the exoelectrogen 11 can use lactic acid produced by the lactic bacterium to produce electrons.

When the anode wire 21 and the cathode wire 31 of the microbial fuel cell 1A having the above-described configuration are connected together through an external circuit, the following microbial fuel cell reaction occurs and electricity can be drawn from the cell.

(Microbial Fuel Cell Reaction)

The following description will discuss a microbial fuel cell reaction in the microbial fuel cell 1A of Embodiment 1 with reference to FIG. 4. FIG. 4 schematically illustrates metabolism by bacteria in the vicinity of the anode 20 of the microbial fuel cell 1A. It should be noted that, although the microorganism-containing substance 10 of Embodiment 1 contains a methanogen as the anaerobic bacterium 14, the anaerobic bacterium 14 is not an essential constituent.

The anaerobic exoelectrogen 11 (e.g., earlier-described Shewanella species or the like) contained in the microorganism-containing substance 10 is adsorbed onto the anode 20, and, when the organic matter OM such as a hydrocarbon (e.g., glucose, acetic acid, or the like), an amino acid, and/or the like contained in the microorganism-containing substance 10 is metabolized (oxidized), an electron (e⁻) is released from the electron transport system toward the anode 20 (Reaction R1). After the oxidization, the organic matter OM becomes an oxidant. This electron (e⁻) passes through an external circuit and reaches the cathode 30, thereby causing electricity generation.

In the vicinity of the anode 20, oxygen Ox may be present. The microorganism-containing substance 10, which has been fed into the fuel chamber 3 through the hole 6, may contain a relatively high concentration of the oxygen Ox, especially in a case where the microorganism-containing substance 10 has not been subjected to deaeration such as bubbling in advance. Furthermore, a part of the oxygen Ox contained in the air chamber 4 may not be consumed at the cathode 30 and pass through the conductive layer 5, pass through or diffuse into the microorganism-containing substance 10, and travel toward the anode 20. In the case where the oxygen Ox is present in the vicinity of the anode 20 as described above, the activity of the anaerobic exoelectrogen 11 decreases.

The microorganism-containing substance 10 of Embodiment 1 further contains at least the aerobic bacterium 13, as described earlier. Therefore, it is possible to consume oxygen in the microorganism-containing substance 10 through metabolism by the aerobic bacterium 13 (Reaction R2).

Since the oxygen concentration in the microorganism-containing substance 10 is lowered through Reaction R2, the oxygen concentration in the vicinity of the anode 20 can be kept low. This helps enhance the activity of the anaerobic exoelectrogen 11 used as an electrode catalyst.

Furthermore, since the microorganism-containing substance 10 of Embodiment 1 further contains a methanogen as the anaerobic bacterium 14, methane and carbon dioxide are produced from the organic matter OM in the microorganism-containing substance 10 through metabolism by the methanogen (Reaction 3). This makes it possible to lower the oxygen concentration in the microorganism-containing substance 10 to a greater extent.

On the other hand, a proton (H⁺) produced together with the electron (e⁻) passes through the microorganism-containing substance 10 and the ion-conductive layer 5 and reaches the cathode 30. The electrons (e⁻), protons (H⁺), and oxygen (O₂) in air and water react at the cathode 30, producing water (H₂O) (Reaction R4). Reactions R1 to R4 are described below.

(Organic matter OM)+H₂O→CO₂+H⁺+e⁻ (Reaction R1)

(Organic matter OM)+O₂→CO₂+H₂O (Reaction R2)

(Organic matter OM)→CH₄+CO₂ (Reaction R3)

O₂+4H⁺+4e⁻→2H₂O (Reaction R4)

As described above, according to the microbial fuel cell 1A of Embodiment 1, oxygen in the microorganism-containing substance 10 is consumed through Reaction R2 of the aerobic bacterium 13 and the like, and thereby the oxygen concentration in the microorganism-containing substance 10 is lowered. In addition, it is possible to hermetically close the fuel chamber 3 by use of the openable/closeable member 7.

It is therefore possible to lower the oxygen concentration of the microorganism-containing substance 10, and possible to create an environment suitable for the anaerobic exoelectrogen 11. The result is that the activity of the exoelectrogen 11 is enhanced and the electric-generating capacity of the microbial fuel cell 1A is increased.

As such, it is not necessary to prepare a microorganism-containing substance 10 having a low oxygen concentration in advance, and it is possible to provide a microbial fuel cell 1A which is easy to install and from which electricity can be drawn regardless of location.

With the use of the microbial fuel cell 1A of Embodiment 1, it is possible to install a self-power-generating sensor or the like with reasonable installation cost, even in locations where an electricity supply is difficult to obtain. Furthermore, since there is no need to provide a fuel sending mechanism such as a pump, it is possible to make a low-cost microbial fuel cell that gives a large net generation.

Furthermore, since it is possible to supply the microorganism-containing substance 10 into the fuel chamber 3, it is possible to prevent running out of the fuel in the fuel chamber 3 and possible to achieve a long-life microbial fuel cell 1A. In addition, since it is possible to operate the microbial fuel cell 1A without excessively increasing the concentration of the fuel in the fuel chamber 3, the microbial fuel cell 1A suffers little loss of fuel. Therefore, the microbial fuel cell 1A can stably generate electricity without disturbing the microorganism environment in the microorganism-containing substance 10.

As such, it is possible to provide a microbial fuel cell 1A which is capable of stably generating electricity and in which a pump or the like for fuel supply is not necessary and low oxygen concentration is maintained in the vicinity of the fuel electrode.

Furthermore, in a case where a plurality of microbial fuel cells 1A are electrically connected, short circuits do not easily occur between electrodes because the microbial fuel cells 1A are individually separated. Therefore, the plurality of microbial fuel cells 1A can be electrically connected in series. Moreover, in a case where the microbial fuel cell 1A is used inside a fuel solution and an electrochemical sensor or the like is used to sense the fuel solution, there is less likelihood of reducing the accuracy of the sensing by a short circuit between electrodes.

### Embodiment 2

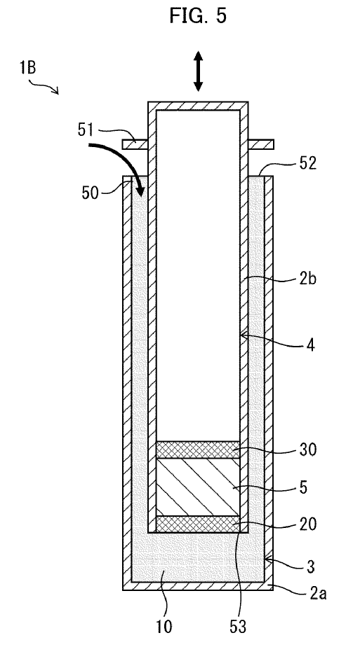

The following description will discuss another embodiment of the present invention with reference to FIG. 5. It should be noted that features of Embodiment 2 other than those described in Embodiment 2 are the same as those of Embodiment 1. For convenience, members having functions identical to those illustrated in the drawings of Embodiment 1 are assigned identical referential numerals and their descriptions are omitted.

FIG. 5 is a longitudinal cross-sectional view schematically illustrating a configuration of a microbial fuel cell 1B of Embodiment 2. The microbial fuel cell 1B includes a first housing 2a and a second housing 2b, in place of the housing 2 of the microbial fuel cell 1A (see FIG. 1). The first housing 2a and the second housing 2b have a hole 50 between them, in place of the hole 6 of the housing 2. Furthermore, the microbial fuel cell 1B has an openable/closeable member 51 in place of the openable/closeable member 7 of the microbial fuel cell 1A.

As illustrated in FIG. 5, the microbial fuel cell 1B of Embodiment 2 includes: the first housing 2a having a first opening 52; and the second housing 2b having a second opening 53. The microbial fuel cell 1B is obtained by inserting the second housing 2b into the first opening 52 of the first housing 2a such that the second opening 53-side end is inserted first.

The first housing 2a has an internal space therein, and this internal space is isolated from the external environment except for the first opening 52. This internal space serves as a fuel chamber 3. The fuel chamber 3 is filled with a microorganism-containing substance 10.

The second housing 2b has an internal space therein, and this internal space is isolated from the external environment except for the second opening 53. The second housing 2b includes, in its internal space, an anode 20, an ion-conductive layer 5, a cathode 30, and an air chamber 4, which are arranged in this order from the second opening 53.

In Embodiment 2, the anode 20, the ion-conductive layer 5, and the cathode 30 are in close contact with each other. The anode 20 and the ion-conductive layer 5 may be provided at a distance from each other.

The second housing 2b has the openable/closeable member 51 on part of the outer surface thereof. The enable/closeable member 51 is provided so as to protrude from the outer surface of the second housing 2b.

The microbial fuel cell 1B is arranged such that the second housing 2b is inserted in the first housing 2a, and that, in the first opening 52, an area formed between the first housing 2a and the second housing 2b serves as the hole 50.

The openable/closeable member 51 is configured to make close contact with and hermetically close the hole 50 when the second housing 2b is inserted into the first housing 2a to a certain extent. This makes it possible to open the hole 50 or close the hole 50 with the openable/closeable member 51 by removing or inserting the second housing 2b from/into the first housing 2a.

Such a configuration makes it possible to replace the anode 20, the ion-conductive layer 5, and the cathode 30 all at once, and therefore the microbial fuel cell 1B is easy to maintain.

### Embodiment 3

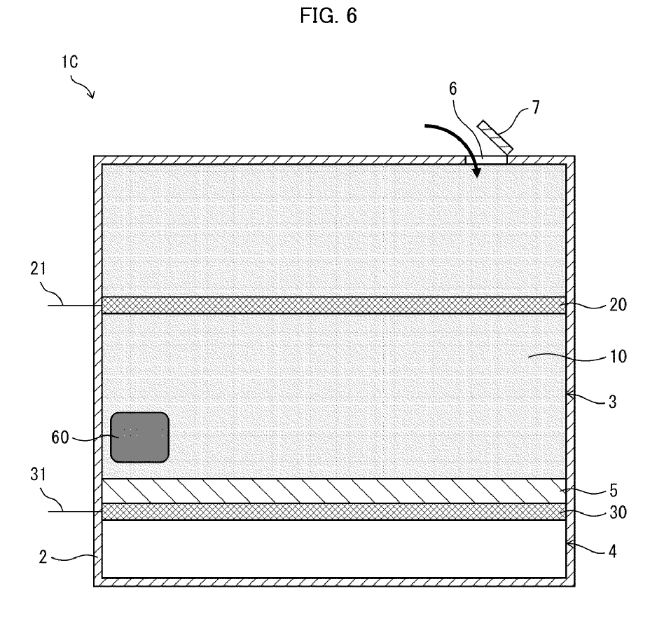

The following description will discuss another embodiment of the present invention with reference to FIG. 6. It should be noted that features of Embodiment 3 other than those described in Embodiment 3 are the same as those of Embodiments 1 and 2. For convenience, members having functions identical to those illustrated in the drawings of Embodiments 1 and 2 are assigned identical referential numerals and their descriptions are omitted.

FIG. 6 is a longitudinal cross-sectional view schematically illustrating a configuration of a microbial fuel cell 1C of Embodiment 3. The microbial fuel cell 1C is different from the microbial fuel cell 1A in that the microbial fuel cell 1C includes a fuel timely-releasing member (fuel timely-releasing mechanism) 60 in a fuel chamber 3 in addition to the constituents of the microbial fuel cell 1A (see FIG. 1).

The fuel timely-releasing member 60 serves to release, into the fuel chamber 3 in a timed manner, a supplemental fuel substance containing at least a substance that can be used by an exoelectrogen 11 for its metabolism. The supplemental fuel substance is released in a controlled manner or released at a selected or predetermined point in time. The supplemental fuel substance contains at least one of an organic matter OM and water. The supplemental fuel substance may contain a substance(s) that can be used for metabolism by any of the microorganisms contained in the microorganism-containing substance 10.

According to the above configuration, after the microorganism-containing substance 10 is filled in the fuel chamber 3, the fuel can be added continuously without having to operate an openable/closeable member 7. This makes it possible to configure a microbial fuel cell that is free from maintenance for a long period of time. As a result, the microbial fuel cell 1C is a long-life cell. The fuel as used herein at least means a substance that the exoelectrogen 11 in the microorganism-containing substance 10 can use. The fuel may contain a substance(s) that is used for metabolism by a microorganism(s) other than the exoelectrogen 11. The same applies to the following descriptions of this specification.

The fuel timely-releasing member 60 is not particularly limited as to its configuration, provided that the fuel timely-releasing member 60 is capable of releasing, into the fuel chamber 3, a supplemental fuel substance in a controlled manner or at a selected or predetermined point in time. The fuel timely-releasing member 60 can be, for example, a fuel bonded to the inside of the fuel chamber 3 with a decomposable material, a fuel covered with a decomposable material, or the like.

The decomposable material is, for example, a material that has a property of decomposing by addition of water, a property of decomposing in the presence of light, a property of decomposing by heat, a property of decomposing by oxidation, and/or the like.

Alternatively, the fuel timely-releasing member 60 may be arranged to release the fuel into the fuel chamber 3 in response to a stimulus from outside the microbial fuel cell 1C.

Alternatively, the fuel timely-releasing member 60 may be arranged such that: a fuel concentration sensing section (not illustrated) is provided to a part of the inside of the fuel chamber 3 so as to make contact with the microorganism-containing substance 10; and, when the fuel concentration in the fuel chamber 3 or in the microorganism-containing substance 10 has become lower than a predetermined threshold, the fuel is released into the fuel chamber 3.

Alternatively, the fuel timely-releasing member 60 may be a fuel storage tank (not illustrated) which is joined to the housing 2 and which stores the fuel therein. In this case, the fuel transferred from the fuel storage tank according to need is supplied into the fuel chamber 3.

Alternatively, a plurality of fuel timely-releasing members 60 may be provided. This makes it possible to provide a microbial fuel cell 1C that is capable of generating electricity for a longer period of time, by arranging the plurality of fuel timely-releasing members 60 such that they release the fuel into the fuel chamber 3 at respective different points in time.

A method of arranging the plurality of fuel timely-releasing members 60 such that they release the fuel into the fuel chamber 3 at respective different points in time is, for example, to cover or cap fuels with decomposable materials of different compositions, different thicknesses, and/or the like.

It is noted here that the multiplication rate of the exoelectrogen 11 increases as the concentration of a fuel increases. Therefore, if the concentration of the fuel is increased rapidly, the multiplication rate of the exoelectrogen 11 also increases accordingly, resulting in an increase in fuel consumption rate. If this is the case, the microbial fuel cell 1C may not be a long-life cell anymore. Therefore, the fuel timely-releasing member 60 needs to be configured such that a desired amount of a fuel is released into the fuel chamber 3 over a long period of time or in installments.

### Embodiment 4

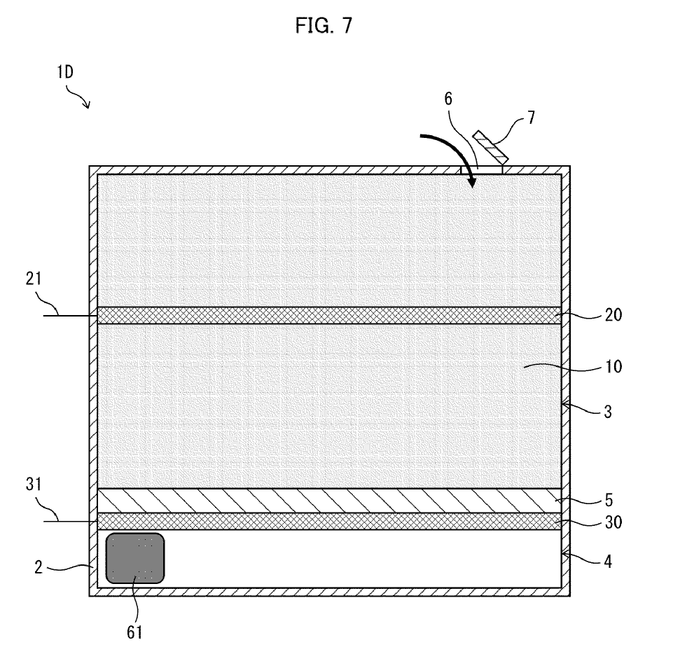

The following description will discuss another embodiment of the present invention with reference to FIG. 7. It should be noted that features of Embodiment 4 other than those described in Embodiment 4 are the same as those of Embodiments 1 to 3. For convenience, members having functions identical to those illustrated in the drawings of Embodiments 1 to 3 are assigned identical referential numerals and their descriptions are omitted.

FIG. 7 is a longitudinal cross-sectional view schematically illustrating a configuration of a microbial fuel cell 1D of Embodiment 4.

The microbial fuel cell 1D is different from the microbial fuel cell 1A in that the microbial fuel cell 1D includes an oxygen timely-releasing member (oxygen timely-releasing mechanism) 61 in an air chamber 4 in addition to the constituents of the microbial fuel cell 1A (see FIG. 1).

The oxygen timely-releasing member 61 is not particularly limited as to its configuration, provided that the oxygen timely-releasing member 61 is capable of releasing, into the air chamber 4 in a timed manner, oxygen in a controlled manner or at a selected or predetermined point in time. For example, the oxygen timely-releasing member 61 can be arranged to use a material such as magnesium peroxide to release oxygen in a controlled manner.

Such an oxygen timely-releasing member 61 makes it possible to configure a microbial fuel cell 1D that is capable of adding oxygen even when the air chamber 4 is in a hermetically closed state and thus is free from maintenance for a long period of time.

Alternatively, the oxygen timely-releasing member 61 may be arranged to release oxygen into the air chamber 4 in response to a stimulus from outside the microbial fuel cell 1D.

Alternatively, the oxygen timely-releasing member 61 may be arranged such that: an oxygen concentration sensing section (not illustrated) is provided inside the air chamber 4; and, when the oxygen concentration in the air chamber 4 has become lower than a predetermined threshold, oxygen is released into the air chamber 4.

Alternatively, the oxygen timely-releasing member 61 may be an oxygen tank (not illustrated) which is joined to the housing 2 and which is capable of releasing oxygen. In this case, oxygen transferred from the oxygen tank according to need is supplied into the air chamber 4. The oxygen tank may be an oxygen cylinder, an oxygen generator, or the like.

Alternatively, a plurality of oxygen timely-releasing members 61 may be provided. This makes it possible to provide a microbial fuel cell 1D that is capable of generating electricity for a longer period of time, by arranging the plurality of oxygen timely-releasing members 61 such that they release oxygen into the air chamber 4 at respective different points in time.

### Embodiment 5

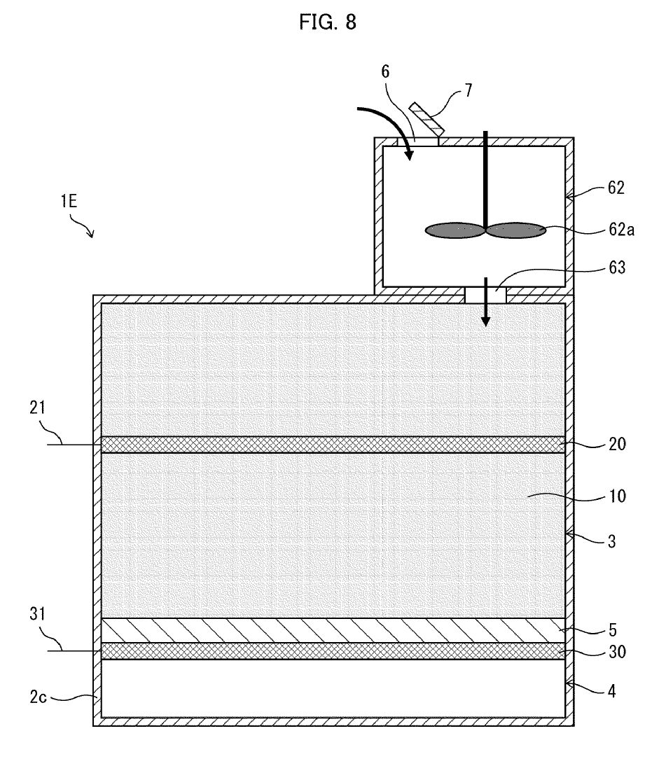

The following description will discuss another embodiment of the present invention with reference to FIG. 8. It should be noted that features of Embodiment 5 other than those described in Embodiment 5 are the same as those of Embodiments 1 to 4. For convenience, members having functions identical to those illustrated in the drawings of Embodiments 1 to 4 are assigned identical referential numerals and their descriptions are omitted.

FIG. 8 is a longitudinal cross-sectional view schematically illustrating a configuration of a microbial fuel cell 1E of Embodiment 5. The microbial fuel cell 1E includes a housing 2c in place of the housing 2 of the microbial fuel cell 1A (see FIG. 1). The housing 2c has a crush stirring chamber (stirring chamber) 62 and a stirrer 62a provided inside the crush stirring chamber 62. The crush stirring chamber 62 has an exit that is in communication with a fuel chamber 3.

As illustrated in FIG. 8, the microbial fuel cell 1E of Embodiment 5 is configured such that the housing 2c has the crush stirring chamber 62 and that the crush stirring chamber 62 has, in its top face, a hole 6 and an openable/closeable member 7. Furthermore, there is a fuel chamber hole 63 in at least part of a wall that defines the fuel chamber 3. The fuel chamber hole 63 and the exit of the crush stirring chamber 62 are in communication with each other.

The crush stirring chamber 62 includes, in its central portion, the stirrer 62a that is capable of stirring a substance inside the crush stirring chamber 62. The stirrer 62a is a fan, for example. The stirrer 62a is not limited, provided that the stirrer 62a is capable of stirring a substance inside the crush stirring chamber 62. The stirrer 62a can be constituted by a known structure.

The crush stirring chamber 62 is not limited, provided that the crush stirring chamber 62 is designed to be able to crush a material such as wet waste. The crush stirring chamber 62 is desirably of a mixer type configured to chop a target substance by rotation of a blade, a mill type configured to mash a target substance between opposing grooves, or the like.

The crush stirring chamber 62 also functions to cause convection of nutrients by causing stirring inside the fuel chamber 3. When the microorganism-containing substance 10 is circulated by convection, the exoelectrogen 11 metabolizes more efficiently and thereby improves electricity generation efficiency.

The stirrer 62a may be operated manually with the use of a handle (not illustrated) or may be operated electrically with the use of a motor (not illustrated). In a case where the stirrer 62a is operated electrically, the electricity for driving the stirrer 62a may be partially constituted by the electromotive force of the microbial fuel cell 1E.

According to the above configuration which includes the crush stirring chamber 62, it is possible to crush organic matter such as wet waste to make it into a fuel substance 12 that is easily useful as a fuel. The fuel substance 12 can be supplied into the fuel chamber 3 as the microorganism-containing substance 10. This makes it possible to use various kinds of organic matter as fuels.

### Embodiment 6

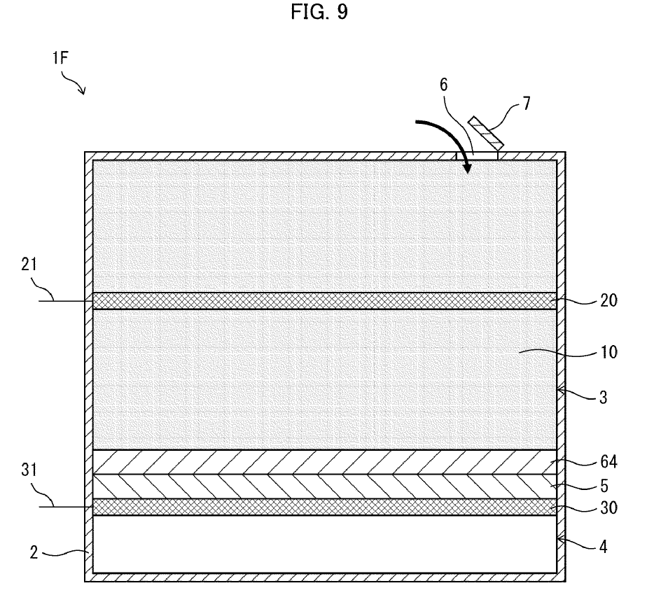

The following description will discuss another embodiment of the present invention with reference to FIG. 9. It should be noted that features of Embodiment 6 other than those described in Embodiment 6 are the same as those of Embodiments 1 to 5. For convenience, members having functions identical to those illustrated in the drawings of Embodiments 1 to 5 are assigned identical referential numerals and their descriptions are omitted.

FIG. 9 is a longitudinal cross-sectional view schematically illustrating a configuration of a microbial fuel cell 1F of Embodiment 6. The microbial fuel cell 1F is different from the microbial fuel cell 1A in that the microbial fuel cell 1F includes a filter layer 64 in addition to the constituents of the microbial fuel cell 1A (see FIG. 1).

The filter layer 64 is disposed in the fuel chamber 3 so as to be in contact with the ion-conductive layer 5. The filter layer 64 serves to prevent the ion-conductive layer 5 from being contaminated with the microorganism-containing substance 10.

The filter layer 64 may have a multilayer structure, but is preferably thinner. The filter layer 64 is preferably a material that is permeable to moisture or ion. The filter layer 64 is preferably a meshed ion conductor.

This makes it possible to keep the ion-conductive layer 5 clean for a long period of time even in a case where the microorganism-containing substance 10, which contains various substances, is used as the fuel solution, and thus possible to configure a microbial fuel cell 1F that generates electricity stably for a long period of time.

### Embodiment 7

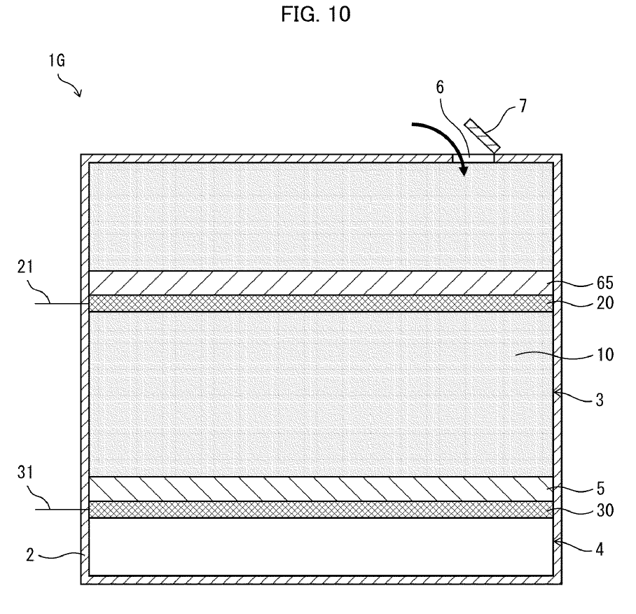

The following description will discuss another embodiment of the present invention with reference to FIG. 10. It should be noted that features of Embodiment 7 other than those described in Embodiment 7 are the same as those of Embodiments 1 to 6. For convenience, members having functions identical to those illustrated in the drawings of Embodiments 1 to 6 are assigned identical referential numerals and their descriptions are omitted.

FIG. 10 is a longitudinal cross-sectional view schematically illustrating a configuration of a microbial fuel cell 1G of Embodiment 7. The microbial fuel cell 1G is different from the microbial fuel cell 1A in that the microbial fuel cell 1G includes an anode filter layer (third layer) 65 in addition to the constituents of the microbial fuel cell 1A.

The anode filter layer 65 is disposed in contact with the anode 20 so as to be closer to a hole 6 than the anode 20 is to the hole 6. The anode filter layer 65 serves to prevent the anode 20 from being clogged with the microorganism-containing substance 10.

The anode filter layer 65 may have a multilayer structure, but is preferably thinner. The anode filter layer 65 is preferably a material that is permeable to moisture or ion. The anode filter layer 65 is preferably a meshed ion conductor.

This makes it possible to prevent the anode 20 from being clogged even in a case where the microorganism-containing substance 10, which contains various substances, is used as the fuel solution, and thus possible to configure a microbial fuel cell 1G that generates electricity stably for a long period of time.

### Embodiment 8

The following description will discuss another embodiment of the present invention with reference to FIG. 11. It should be noted that features of Embodiment 8 other than those described in Embodiment 8 are the same as those of Embodiments 1 to 7. For convenience, members having functions identical to those illustrated in the drawings of Embodiments 1 to 7 are assigned identical referential numerals and their descriptions are omitted.

FIG. 11 is a longitudinal cross-sectional view schematically illustrating a configuration of a microbial fuel cell 1H of Embodiment 8. The microbial fuel cell 1H is different from the microbial fuel cell 1A in that the microbial fuel cell 1H has a cover 66 as a heat insulator that surrounds a housing 2, in addition to the constituents of the microbial fuel cell 1A (see FIG. 1).

The cover 66 covers the housing 2 so as to protect against the external environment. The cover 66 can protect the internal space of the housing 2 against the outside atmosphere. The material for the cover 66 is preferably a highly water-proof, highly heat-insulating material, which can be, for example, resin, rubber, foam, or the like. In a case where a plurality of microbial fuel cells 1H are connected electrically, the microbial fuel cells 1H may be covered by respective covers 66 or may be all covered collectively by a single cover 66.

Although the cover 66 of Embodiment 8 is in close contact with the housing 2, the cover 66 and the housing 2 may be separate from each other.

It should be noted here that the effects the outside atmosphere has on the microorganism-containing substance 10 are, for example, as described below. That is, although the microorganism-containing substance 10 contains moisture and desirably has fluidity and/or ion conductivity, if the moisture freezes due to the influence of the outside atmosphere, this may affect cell performance.

The microbial fuel cell 1H of Embodiment 8 includes the cover 66 and thus has a heat-insulated structure. This obviates the above effects.

From the above point of view, the microorganism-containing substance 10 preferably contains, in addition to the moisture, a freezing-point depressant (antifreeze) 67 to lower the freezing point of water. In a case where the microorganism-containing substance 10 contains the freezing-point depressant 67, it is possible to prevent the moisture in the microorganism-containing substance 10 from freezing even in an environment in which water freezes, and possible to ensure the fluidity, ion conductivity, and the like. The freezing-point depressant 67 may be a solute soluble in water, and may be, for example, a salt or the like. Alternatively, the freezing-point depressant 67 may be an organic solvent such as an alcohol.

### Embodiment 9

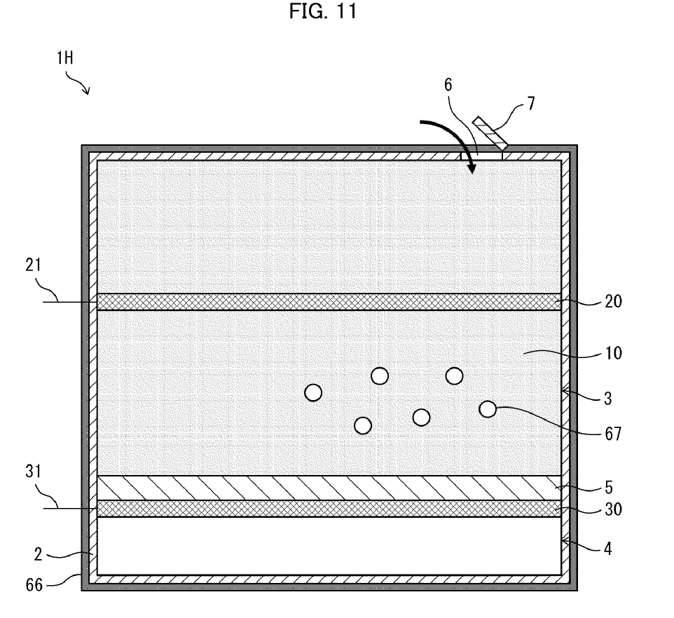

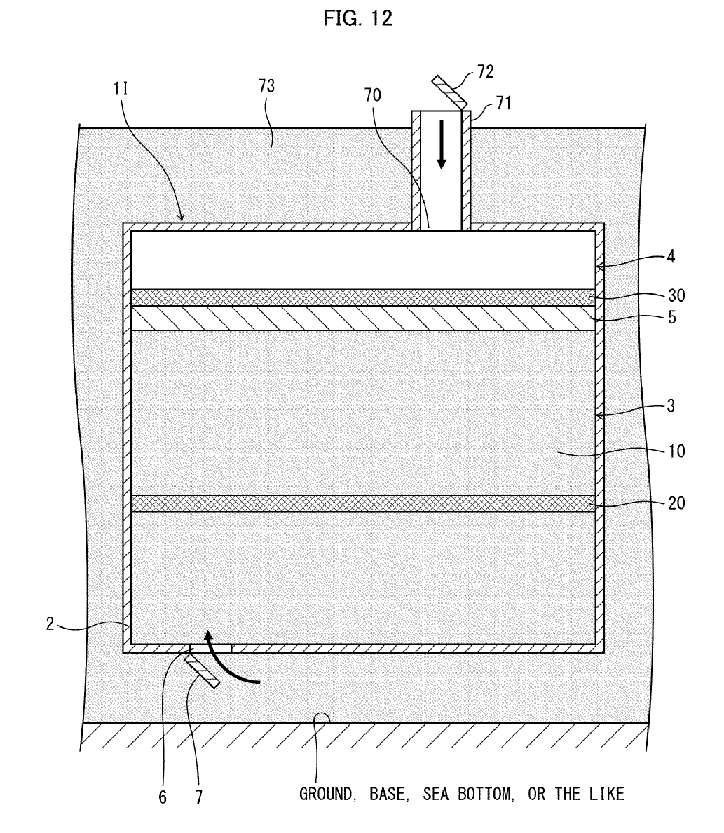

The following description will discuss another embodiment of the present invention with reference to FIG. 12. It should be noted that features of Embodiment 9 other than those described in Embodiment 9 are the same as those of Embodiments 1 to 8. For convenience, members having functions identical to those illustrated in the drawings of Embodiments 1 to 8 are assigned identical referential numerals and their descriptions are omitted.

FIG. 12 is a longitudinal cross-sectional view schematically illustrating a configuration of a microbial fuel cell 1I of Embodiment 9. The microbial fuel cell 1I is different from the microbial fuel cell 1A in that the microbial fuel cell 1I has an air intake hole 70 and an air intake pipe 71 connected to the air intake hole 70 in addition to the constituents of the microbial fuel cell 1A (see FIG. 1). The air intake hole 70 is in a portion of the wall of an air chamber 4, and allows the air chamber 4 and the external environment outside the air chamber 4 to communicate with each other.

As illustrated in FIG. 12, the microbial fuel cell 1I of Embodiment 9 is situated inside a microorganism mixture bath (fuel substance bath) 73. The microbial fuel cell 1I in FIG. 12 is shown upside down from the microbial fuel cell 1A in FIG. 1.

The air intake hole 70 is in at least part of the wall of the air chamber 4. The microbial fuel cell 1I of Embodiment 9 is configured such that the air intake hole 70 is connected to the air intake pipe 71. The air intake pipe 71 is not limited, provided that the air intake pipe 71 is a hollow pipe, tube, or the like, but is preferably a highly water-proof metal, plastic material, or the like. An arrangement in which an anode wire and a cathode wire (these are not illustrated) pass through the air intake pipe 71 may also be employed.

By employing an arrangement in which an end of the air intake pipe 71 is exposed to, for example, ambient air, it is possible to supply oxygen to the air chamber 4 in a state in which the microbial fuel cell 1I is situated inside the microorganism mixture bath 73. The length of the air intake pipe 71 may be selected appropriately according to conditions of use.

The air intake pipe 71 may be omitted. In this case, an arrangement in which the air intake hole 70 is directly exposed to ambient air may be employed.

The air intake pipe 71 may have an air intake openable/closeable member 72. The air intake openable/closeable member 72 can be brought into an open state at a selected or predetermined point in time, and thereby oxygen can be supplied to the air chamber 4. The air intake openable/closeable member 72 needs to be in a closed state at least when the end of the air intake pipe 71 is situated inside the microorganism mixture bath 73.

The following arrangement may be employed: no air intake pipe 71 is provided; and the air intake hole 70 is provided with the air intake openable/closeable member 72.

The microorganism mixture bath 73 can be used as the microorganism-containing substance 10 in the fuel chamber 3.

By bringing an openable/closeable member 7 into the open state, it is possible to supply the microorganism-containing substance 10 from the microorganism mixture bath 73 into the fuel chamber 3 or possible to replace the microorganism-containing substance 10 in the fuel chamber 3.

As has been described, the microbial fuel cell 1I of Embodiment 9 includes the air intake pipe 71. This makes it possible to supply oxygen to the air chamber 4 even in a case where the microbial fuel cell 1I is situated inside the microorganism mixture bath 73, and thus possible to prevent lack of oxygen in the vicinity of the cathode 30 and to thereby achieve a microbial fuel cell usable for a long period of time.

### Embodiment 10

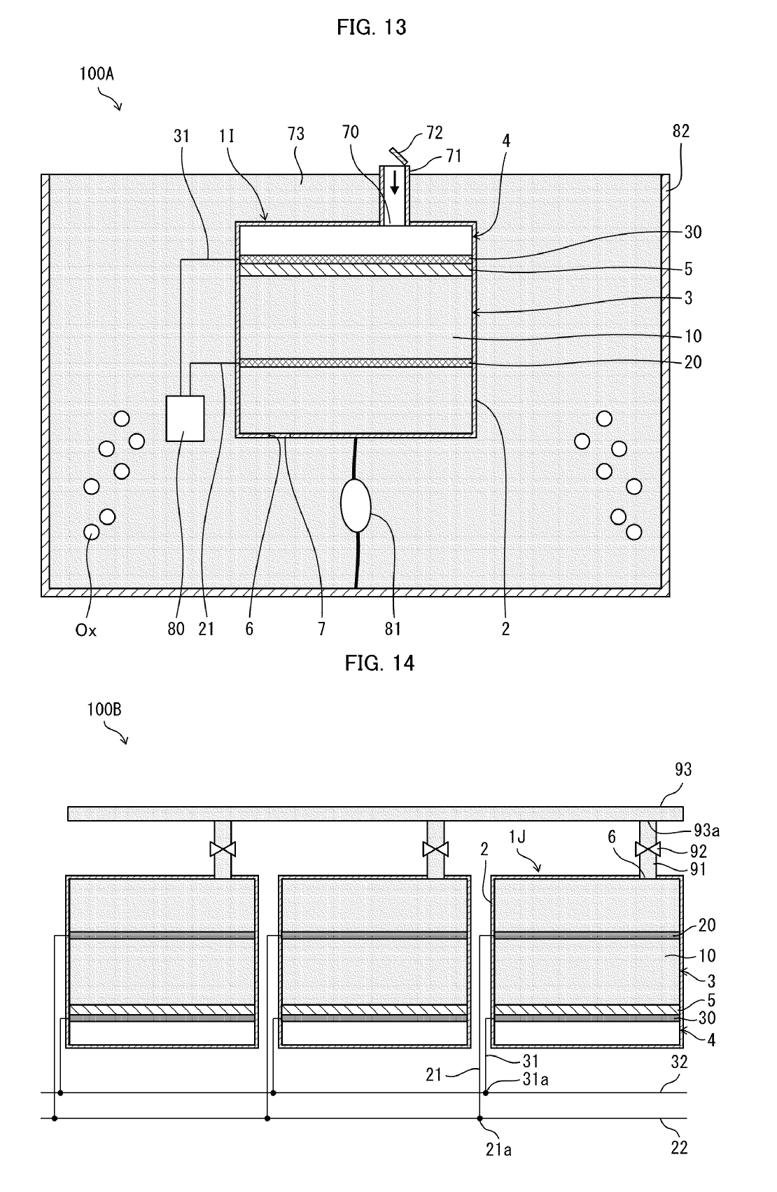

The following description will discuss another embodiment of the present invention with reference to FIG. 13. It should be noted that features of Embodiment 10 other than those described in Embodiment 10 are the same as those of Embodiments 1 to 9. For convenience, members having functions identical to those illustrated in the drawings of Embodiments 1 to 9 are assigned identical referential numerals and their descriptions are omitted.

FIG. 13 is a longitudinal cross-sectional view schematically illustrating a configuration of a microbial fuel cell system 100A of Embodiment 10. As illustrated in FIG. 13, the microbial fuel cell system 100A includes a microbial fuel cell 1I and a sensor 80 configured to be driven by electricity generated by the microbial fuel cell 1I. The microbial fuel cell 1I and the sensor 80 are situated inside a microorganism mixture bath 73.

It should be noted that the microbial fuel cell 1I of Embodiment 10 has the same configuration as the microbial fuel cell 1I (see FIG. 12) described in Embodiment 9.

The microorganism mixture bath 73 is soil or mud that is rich in organic matter, anaerobic bacteria, and aerobic bacteria. In other words, the microorganism mixture bath 73 contains a microorganism-containing substance 10.

By bringing an openable/closeable member 7 into an open state, it is possible to allow the surrounding microorganism mixture bath 73 to enter the fuel chamber 3 as the microorganism-containing substance 10.

The sensor 80 is a device configured to sense the state of the microorganism mixture bath 73. By keeping the openable/closeable member 7 in a closed state while the sensor 80 is supplied with electricity, it is possible to drive the sensor 80 while preventing electrochemical short-circuits between the microorganism mixture bath 73 and the microorganism-containing substance 10. The result of sensing with the sensor 80 may be made perceivable outside the microbial fuel cell system 100A with the use of a notifier (not illustrated). It is desirable that the notifier is also driven by the electromotive force of the microbial fuel cell. The sensor 80 is, for example, a sensor device configured to sense PH, concentration of a certain substance, and/or the like. The notifier is, for example, a radio transmitter.

In FIG. 13, the microorganism mixture bath 73 may be surrounded by a reaction treatment tank 82. A housing 2 is held in a fixed position in relation to the reaction treatment tank 82 with a weight or anchor 81. The reaction treatment tank 82 may have a specific mechanism to supply oxygen Ox in order to enhance the activity of the aerobic bacteria. This is generally called an aeration tank in water treatment plants.

As has been described, when the openable/closeable member 7 is in the closed state in this arrangement, the microorganism-containing substance 10 in the fuel chamber 3 is caused to have a highly active exoelectrogen 11 therein, unlike the microorganism mixture bath 73. This enables electricity generation even in a case where the reaction treatment tank 82 is an aeration tank.

As has been described, according to the microbial fuel cell system 100A, even in a case where the microorganism mixture bath 73 is supplied into the fuel chamber 3 to be used as the microorganism-containing substance 10, it is possible to drive the sensor 80 while preventing electrochemical short-circuits between the microorganism mixture bath 73 and the microorganism-containing substance 10, by placing the openable/closeable member 7 in the closed state while the sensor 80 is supplied with electricity.

### Embodiment 11

The following description will discuss another embodiment of the present invention with reference to FIG. 14. It should be noted that features of Embodiment 11 other than those described in Embodiment 11 are the same as those of Embodiments 1 to 10. For convenience, members having functions identical to those illustrated in the drawings of Embodiments 1 to 10 are assigned identical referential numerals and their descriptions are omitted.

FIG. 14 is a longitudinal cross-sectional view schematically illustrating a configuration of a microbial fuel cell system 100B of Embodiment 11.

As shown in FIG. 14, in the microbial fuel cell system 100B, a plurality of microbial fuel cells 1J are electrically corrected in parallel. Each of the microbial fuel cells 1J may have the configuration of any of the microbial fuel cells 1A to 1I.

The microbial fuel cells 1J may be connected in series or may be connected in series and parallel.

The microbial fuel cells 1J have respective holes 6, which are connected to a fuel pipe 93 via respective fuel supply pipes 91.

The fuel pipe 93 serves to carry the microorganism-containing substance 10. It is possible to supply the microorganism-containing substance 10 into respective fuel chambers 3 of the microbial fuel cells 1J from the fuel pipe 93.

Each of the holes 6 of the respective microbial fuel cells 1J can be opened and closed with an openable/closeable member 92. The fuel supply pipes 91 may be detachably attached to the fuel pipe 93 at contact points 93a.

Anode wires 21 of the plurality of microbial fuel cells 1J are connected to a common anode wire 23 at respective anode contact points 22. Similarly, cathode wires 31 of the plurality of microbial fuel cells 1J are connected to common cathode wire 33 at respective cathode contact points 32.

By employing an arrangement in which the connections at the anode contact points 22 and the cathode contact points 32 are made by connectors, it is possible to easily carry out maintenance operations such as desired wire rearrangements, replacement of microbial fuel cells 1J, and the like.

Since a plurality of microbial fuel cells 1J are electrically connected, the microbial fuel cell system 100B is capable of generating large power outputs. Furthermore, since the microbial fuel cell system 100B includes the fuel pipe 93, it is possible to fill a fuel solution into the fuel chambers 3 of the respective microbial fuel cells 1J all at once. In addition, since the openable/closeable members 92 enable hermetical closing of the fuel chambers 3 of the respective microbial fuel cells 1J, it is possible to prevent oxygen from flowing into the fuel chambers 3 and also possible to avoid short circuits between the fuel chambers 3. This makes it possible to connect microbial fuel cells in series.

### Embodiment 12

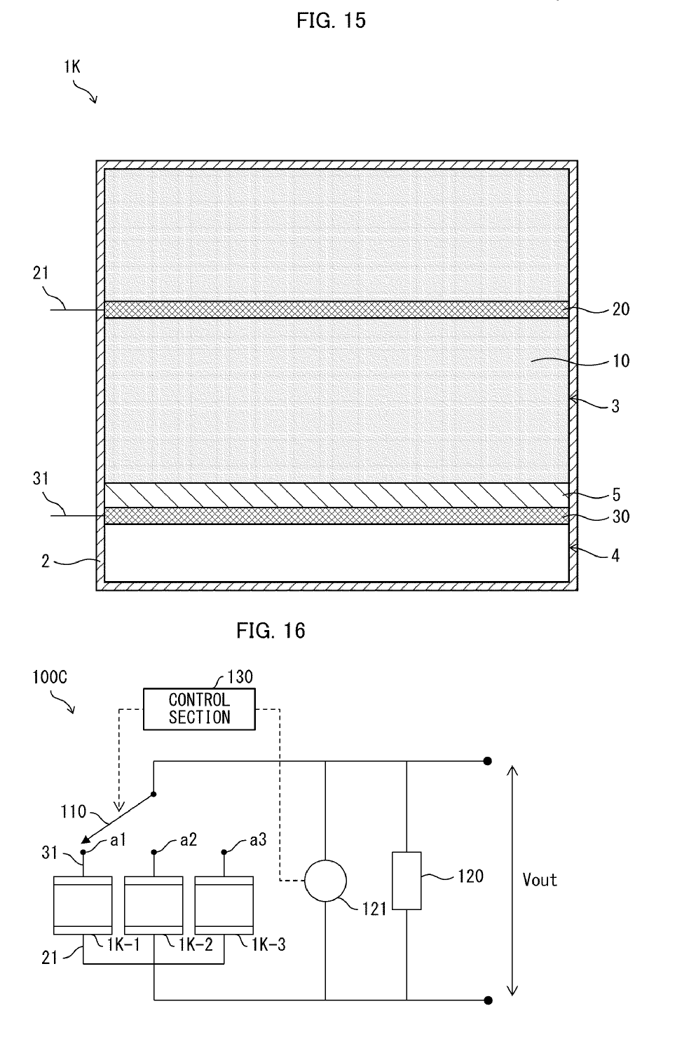

The following description will discuss another embodiment of the present invention with reference to FIGS. 15 to 18. It should be noted that features of Embodiment 12 other than those described in Embodiment 12 are the same as those of Embodiments 1 to 11. For convenience, members having functions identical to those illustrated in the drawings of Embodiments 1 to 11 are assigned identical referential numerals and their descriptions are omitted.

Until now, development has been made on microbial fuel cells for clean energy and/or energy harvesting. For example, as disclosed in Patent Literature 3, a microbial fuel cell which generates electricity from mud and which is connected in series with a dry cell to thereby extend its life is disclosed.

Furthermore, as disclosed in Patent Literature 4, a microbial fuel cell provided with a constant voltage circuit for controlling the output of the microbial fuel cell at a predetermined voltage is disclosed.

However, with the techniques disclosed in Patent Literatures 3 and 4 described above, electricity output from the microbial fuel cell gradually decreases with time, and, after a certain period of time, the electricity will become less than required for a power supply target.

Specifically, in regard to the microbial fuel cell disclosed in Patent Literature 3, the life of the microbial fuel cell is extended by connecting it in series with a dry cell. However, the dry cell has a limited capacity. Therefore, after the capacity has been used up, the amount of electricity generation decreases. That is, it is not possible to achieve a microbial fuel cell that is capable of generating electricity stably for a long period of time.

Furthermore, in a case of a microbial fuel cell that is not specifically designed to have constant supply of fuel (i.e., not specifically designed to cause convection), electricity generation proceeds in a diffusion-controlled manner, and this necessarily results in a gradual decrease in amount of electricity generation.

A typical way to achieve stable output is to improve the output performance of the microbial fuel cell. However, since the output electricity also has a physical limitation, this way alone is not enough to solve the above issue.

Embodiment 12 was made in view of the above issue, and an object thereof is to provide a microbial fuel cell system that is capable of constantly supplying a certain amount or more of electricity to a load stably for a long period of time.

FIG. 15 is a longitudinal cross-sectional view schematically illustrating a configuration of a microbial fuel cell 1K of Embodiment 12. The microbial fuel cell 1K is different from the microbial fuel cell 1A (see FIG. 1) in that the microbial fuel cell 1K does not have the hole 6 or the openable/closeable member 7. A method of introducing a microorganism-containing substance 10 into a fuel chamber 3 of the microbial fuel cell 1K is not particularly limited. The microorganism-containing substance 10 may be carried with the use of a pump like, for example, the invention disclosed in Patent Literature 1.

FIG. 16 schematically illustrates a microbial fuel cell system 100C of Embodiment 12. As illustrated in FIG. 16, the microbial fuel cell system 100C includes: three microbial fuel cells (i.e., microbial fuel cell 1K-1, microbial fuel cell 1K-2, and microbial fuel cell 1K-3) connected in parallel with each other; and mutually connected anode wires 21 of the respective microbial fuel cells.

The microbial fuel cell 1K-1, microbial fuel cell 1K-2, and microbial fuel cell 1K-3 have respective cathode wires 31, which have respective contact points a1, a2, and a3. The contact points a1, a2, and a3 are selectively connected to a changeover switch 110. Specifically, the microbial fuel cell system 100C is designed such that selected one of the contact points a1, a2, and a3 and the changeover switch 110 are connected to each other. In FIG. 16, the contact point a1 of the cathode wire 31 of the microbial fuel cell 1K-1 and the changeover switch 110 are connected to each other.

The contact points a1, a2, and a3 may alternatively be located on the anode wires 21.

The anode wires 21 and the selected cathode wire 31 are connected to a load 120 and an output sensing section 121. Furthermore, the output sensing section 121 and the changeover switch 110 are connected to a control section 130.

Here, when the microbial fuel cell system 100C is in the condition shown in FIG. 16, the microbial fuel cell 1K-1, which is selected and connected to the changeover switch 110, is connected to the load 120 and discharges electricity. On the other hand, the microbial fuel cell 1K-2 and the microbial fuel cell 1K-3, which are not connected to the changeover switch 110, are not discharging electricity but are being charged with electricity.

The output sensing section 121 is connected in series or in parallel with the load 120 and monitors the output (electric current or voltage) of the microbial fuel cell that is discharging electricity. When the output sensing section 121 has sensed an output that is below a predetermined threshold, the control section 130 controls the changeover switch 110 to disconnect from the currently-connected microbial fuel cell and connect to another microbial fuel cell. Alternatively, the following arrangement may be employed: before the output sensed by the output sensing section 121 becomes lower than a predetermined threshold, the control section 130 selects a microbial fuel cell whose output sensed by the output sensing section 121 is equal to or greater than the predetermined threshold and causes the changeover switch 110 to connect to the selected microbial fuel cell. This makes it possible to construct a microbial fuel cell system 100C that is capable of stably outputting a certain amount or more of electricity. This will be described below in more detail.

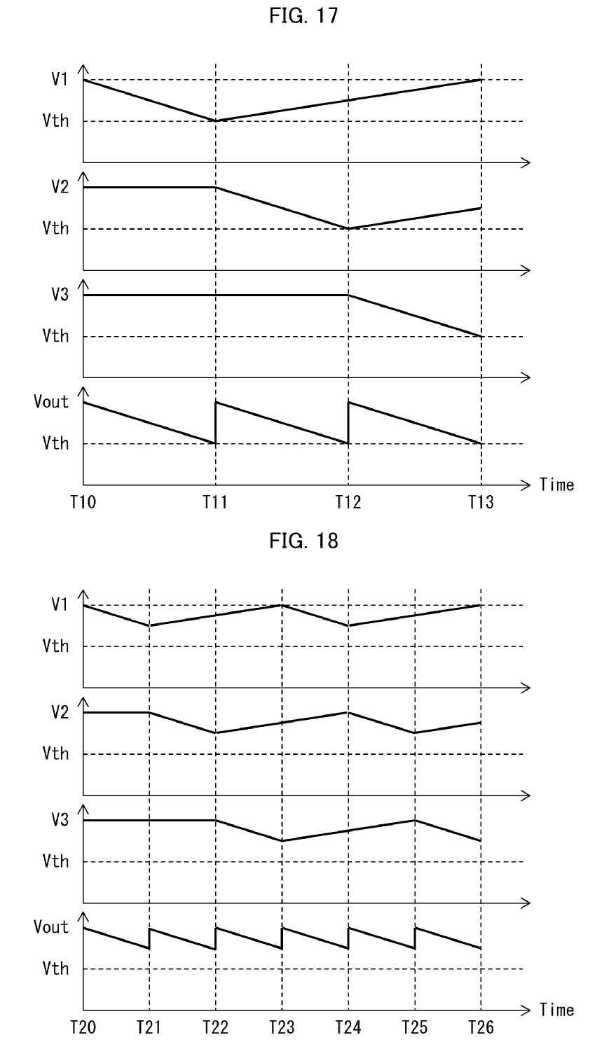

FIG. 17 is a graph schematically illustrating how output voltage changes when each microbial fuel cell of the microbial fuel cell system 100C of Embodiment 12 operates. In FIG. 17, the horizontal axis shows time and the vertical axis shows voltages V1 to V3 of the microbial fuel cells 1K-1 to 1K-3 and output voltage Vout of the microbial fuel cell system 100C.

In FIG. 17, at time T10, the changeover switch 110 is connected to the contact point a1 and the microbial fuel cell 1K-1 is discharging electricity. In this condition, V1 and Vout gradually decrease with time. In the meantime, the microbial fuel cell 1K-2 and the microbial fuel cell 1K-3 are not in connection with the circuitry and are in an inactive state.

Then, upon sensing by the output sensing section 121 that the monitored voltage V1 of the microbial fuel cell 1K-1 has decreased to a threshold Vth (T11), the control section 130 controls the changeover switch 110 to disconnect from the microbial fuel cell 1K-1 and connect to the microbial fuel cell 1K-2. This causes the microbial fuel cell 1K-2, which was in the inactive state, to start discharging electricity, resulting in a rise of output (Vout) of the microbial fuel cell system 100C.

The microbial fuel cells here have similar characteristics to capacitors. Specifically, in a state in which the anode 20 and the cathode 30 are open (the anode wire 21 and the cathode wire 31 are not electrically connected), the microbial fuel cells can be charged with electricity by a microbiological electric generation cycle, that is, the microbial fuel cells can store electric charge therein and increase in voltage across the electrodes. Therefore, the microbial fuel cell 1K-1, when disconnected from the circuitry, starts being charged by the microbiological electric generation cycle, and thus V1 starts rising.

Similarly, upon sensing by the output sensing section 121 that the monitored voltage V2 of the microbial fuel cell 1K-2 has decreased to the threshold Vth (T12), the control section 130 controls the changeover switch 110 to disconnect from the microbial fuel cell 1K-2 and connect to the microbial fuel cell 1K-3. This causes the microbial fuel cell 1K-3, which was in the inactive state, to start discharging electricity, resulting in a rise of output (Vout) of the microbial fuel cell system 100C. The microbial fuel cell 1K-2, when disconnected from the circuitry, starts being charged by the microbiological electric generation cycle, and thus V2 starts rising.

Similarly, upon sensing by the output sensing section 121 that the monitored voltage V3 of the microbial fuel cell 1K-3 has decreased to the threshold Vth (T13), the control section 130 controls the changeover switch 110 to disconnect from the microbial fuel cell 1K-3 and connect to the microbial fuel cell 1K-1. This causes the microbial fuel cell 1K-1, which was in a charging state, to start discharging electricity, resulting in a rise of output (Vout) of the microbial fuel cell system 100C. The microbial fuel cell 1K-3, when disconnected from the circuitry, starts being charged by the microbiological electric generation cycle, and thus V3 starts rising. It should be noted that Vth is desirably selected such that V1 should have recovered its initial state by this time (T13).

FIG. 18 is a graph illustrating another example of how output voltage changes when each microbial fuel cell of the microbial fuel cell system 100C of Embodiment 12 operates. In FIG. 18, the vertical axis shows the voltages V1 to V3 of the microbial fuel cells 1K-1 to 1K-3 and the output voltage Vout of the microbial fuel cell system 100C.

In FIG. 18, the control section 130 is different from FIG. 17 in that the control section 130 changes the connection of the changeover switch 110 at points in time predetermined by a timer, instead of using the threshold Vth. Specifically, the control section 130 changes the connection of the changeover switch 110 such that: the changeover switch 110 is connected to the microbial fuel cell 1K-1 during a period from T20 to T21; the changeover switch 110 is connected to the microbial fuel cell 1K-2 during a period from T21 to T22; the changeover switch 110 is connected to the microbial fuel cell 1K-3 during a period from T22 to T23; and the changeover switch 110 is reconnected to the microbial fuel cell 1K-1 during a period from T23 to T24. Also in this case, the timer is desirably set such that V1 should have recovered its initial state by time T23.

As has been described, the microbial fuel cells are selectively brought into their discharging or charging state, and this electricity generation cycle is repeated. This makes it possible to provide a microbial fuel cell system 100C that is capable of constantly supplying a certain amount or more of electricity to a load stably for a long period of time.

Even in a case where the microbial fuel cells used here are low-power microbial fuel cells, sequentially discharging each of the microbial fuel cells makes it possible to supply stable electricity from the microbial fuel cell system 100C as a whole.

Although the number of the microbial fuel cells 1K constituting the microbial fuel cell system 100C used here is three, the number of the microbial fuel cells 1K constituting the microbial fuel cell system 100C is not limited to three, provided that the number is two or more.

Furthermore, it is desirable that the output sensing section 121 and the changeover switch 110 are driven by electricity supplied from the microbial fuel cells 1K.

The following arrangement may also be employed: for prevention of loss of electricity at a moment when the control section 130 changes the connection of the changeover switch 110, the changeover switch 110 is designed to be connectable to two or more terminals at once. Specifically, in FIG. 16, the changeover switch 110 may be connected to two contact points (the contact point al and the contact point a2) such that the contact point al and the contact point a2 are connected in parallel. For example, when the connection of the changeover switch 110 is changed from the contact point a1 to the contact point a3 while keeping its connection with the contact point a2, the loss of electricity at a moment of the change can be prevented because the connection at the contact point a2 is maintained.

The microbial fuel cell system 100C may include any of the microbial fuel cells 1A to 1I described earlier in place of the microbial fuel cells 1K.

### Embodiment 13

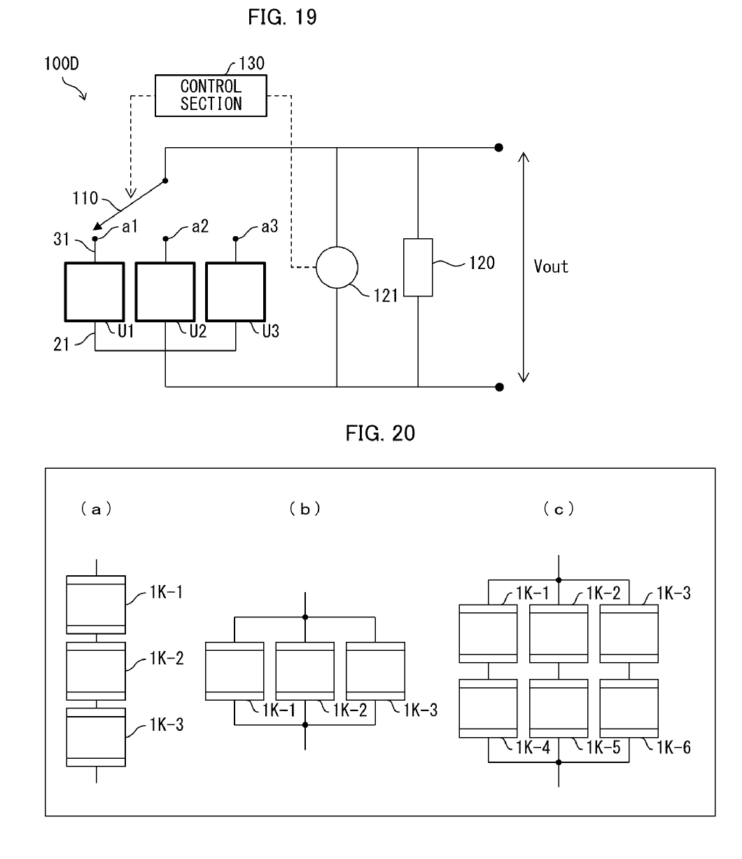

The following description will discuss another embodiment of the present invention with reference to FIGS. 19 and 20. It should be noted that features of Embodiment 13 other than those described in Embodiment 13 are the same as those of Embodiments 1 to 12. For convenience, members having functions identical to those illustrated in the drawings of Embodiments 1 to 12 are assigned identical referential numerals and their descriptions are omitted.

FIG. 19 schematically illustrates a microbial fuel cell system 100D of Embodiment 13. As illustrated in FIG. 19, the microbial fuel cell system 100D is different from the microbial fuel cell system 100C of an example illustrated in FIG. 18 in that the microbial fuel cell system 100D includes microbial fuel cell units U1 to U3 in place of the microbial fuel cells 1K-1 to 1K-3.

FIG. 20 illustrates example configurations of the microbial fuel cell units U1 to U3 of the microbial fuel cell system 100D. Each of the microbial fuel cell units U1 to U3 may be constituted by, for example, the microbial fuel cells 1K-1 to 1K-3 connected in series with each other as illustrated in (a) of FIG. 20 or connected in parallel with each other as illustrated in (b) of FIG. 20. Alternatively, each of the microbial fuel cell units U1 to U3 may be constituted by, for example, six microbial fuel cells, i.e., microbial fuel cells 1K-1 to 1K-6, which are connected in series and parallel with each other as illustrated in (c) of FIG. 20.

Although the number of the microbial fuel cell units constituting the microbial fuel cell system 100D here is three, the number of the microbial fuel cell units constituting the microbial fuel cell system 100D is not limited to three, provided that the number is two or more.

Providing such microbial fuel cell units U1 to U3 makes it possible to constitute a high-power (high-voltage or high-current) microbial fuel cell system 100D without necessitating complex control.

The microbial fuel cells 1K included in the microbial fuel cell units of the microbial fuel cell system 100D may be replaced with any of the microbial fuel cells 1A to 1I described earlier.

### Embodiment 14

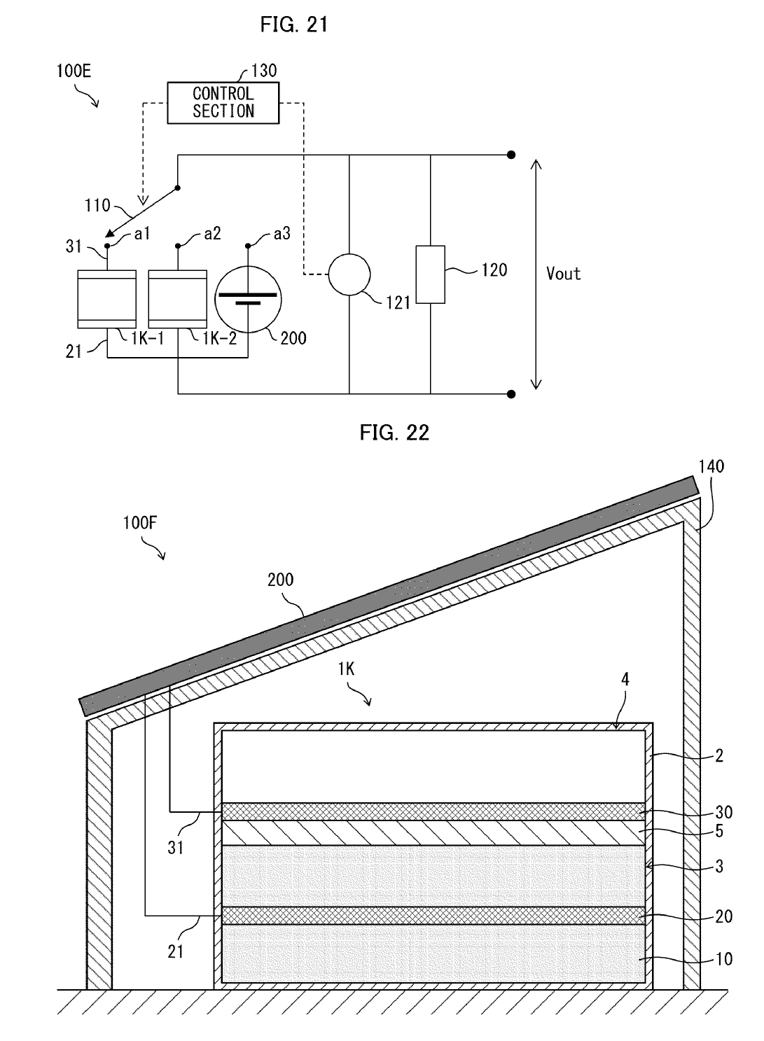

The following description will discuss another embodiment of the present invention with reference to FIG. 21. It should be noted that features of Embodiment 14 other than those described in Embodiment 14 are the same as those of Embodiments 1 to 13. For convenience, members having functions identical to those illustrated in the drawings of Embodiments 1 to 13 are assigned identical referential numerals and their descriptions are omitted.

In conventional energy harvesting utilizing an environment, such as photovoltaic electricity generation, the electricity generation stops in response to changes in the environment (in the case of photovoltaic electricity generation, the electricity generation stops when light is no longer available). That is, for photovoltaic electricity generation, it is difficult to constantly supply electricity because electricity generation stops when sun exposure is unavailable like at night.

Embodiment 14 was made in view of the above issue, and an object thereof is to provide a microbial fuel cell system that employs a combination of a microbial fuel cell and photovoltaic electricity generation (solar cell) and thereby constantly and stably supplies electricity.

FIG. 21 schematically illustrates a microbial fuel cell system 100E of Embodiment 14. As illustrated in FIG. 21, the microbial fuel cell system 100E is different from the microbial fuel cell system 100C illustrated in FIG. 16 in that the microbial fuel cell system 100E includes a solar cell 200 connected in parallel with microbial fuel cells 1K-1 and 1K-2.

The control section 130 is configured to control a changeover switch 110 to: connect to the solar cell 200 at a higher priority under intense light like during the daytime; and connect to the microbial fuel cell 1K-1 or 1K-2 at a higher priority under weak light like at night. An output sensing section 121 of Embodiment 14 may be configured to sense the electromotive force across the terminals of the solar cell 200 or to sense illuminance around it.

This makes it possible to achieve a microbial fuel cell system 100E in which, under a condition in which electricity generation by the solar cell 200 is not available, the microbial fuel cell 1K-1 and/or the microbial fuel cell 1K-2 can supply electricity and, under a condition in which electricity generation by the solar cell 200 is available, the microbial fuel cells 1K-1 and 1K-2 can be charged with electricity. According to the microbial fuel cell system 100E, it is possible to stably supply electricity at any time of day or night in all weathers.

The microbial fuel cells 1K of the microbial fuel cell system 100E may be replaced with any of the microbial fuel cells 1A to 1I earlier described.

### Embodiment 15

The following description will discuss another embodiment of the present invention with reference to FIG. 22. It should be noted that features of Embodiment 15 other than those described in Embodiment 15 are the same as those of Embodiments 1 to 14. For convenience, members having functions identical to those illustrated in the drawings of Embodiments 1 to 14 are assigned identical referential numerals and their descriptions are omitted.

Conventionally, a photovoltaic electricity generating system supported on a base construction has an unused space below it. Such a space is a useless space which, in some cases, even requires maintenance such as weeding.

Embodiment 15 was made in view of the above issue, and an object thereof is to provide a microbial fuel cell system that makes effective use of land and thereby increases the amount of electricity generation per unit of area occupied by the system.

FIG. 22 is a longitudinal cross-sectional view schematically illustrating a configuration of a microbial fuel cell system 100F of Embodiment 15. As illustrated in FIG. 22, the microbial fuel cell system 100F includes a microbial fuel cell 1K and a solar cell 200, which serve as an electric feeder section that constitutes the microbial fuel cell system 100F. The microbial fuel cell system 100F is characterized in that the solar cell 200 is positioned highest and the microbial fuel cell 1K is positioned below the solar cell 200.

Specifically, for example, the solar cell 200 is situated on a base construction 140. The base construction 140 has, when viewed in a cross section, two walls and an inclined roof supported by the two walls. That is, the solar cell 200 is situated on this inclined roof.

The microbial fuel cell 1K is situated within a space below the solar cell 200, the space being defined by the two walls and the inclined roof. The solar cell 200 is electrically connected with an anode wire 21 and a cathode wire 31 of the microbial fuel cell 1K.

Since the microbial fuel cell 1K is situated under the roof, the microbial fuel cell 1K is not susceptible to the weather, such as direct sunlight, rain, and wind, and thus electricity generation can be carried out more stably. Furthermore, the space right below the solar cell 200, which has not been made effective use of, can be made use of by the microbial fuel cell 1K to generate electricity. In FIG. 22, the microbial fuel cell 1K may be buried in the ground.

This makes it possible to provide a microbial fuel cell system 100F that makes effective use of land and thereby increases the amount of electricity generation per unit of area occupied by the system.

Alternatively, the roof of the base construction 140 may be omitted and the solar cell 200 may also serve as the roof. In this case, it is preferable that the area occupied by the microbial fuel cell 1K is smaller than the area of the solar cell 200 projected on the ground.

Alternatively, the following arrangement may be employed: in FIG. 22, a plurality of microbial fuel cells 1K are arranged along a direction going away from a viewer of FIG. 22; or a plurality of sets of the solar cell 200 and the microbial fuel cell 1K are electrically connected to each other.

In Embodiment 15, the anode wire 21 and the cathode wire 31 are connected in the same manner as, for example, those of the microbial fuel cell system 100E shown in FIG. 21.

The microbial fuel cell 1K of the microbial fuel cell system 100F may be replaced with any of the microbial fuel cells 1A to 1I described earlier.

### Embodiment 16

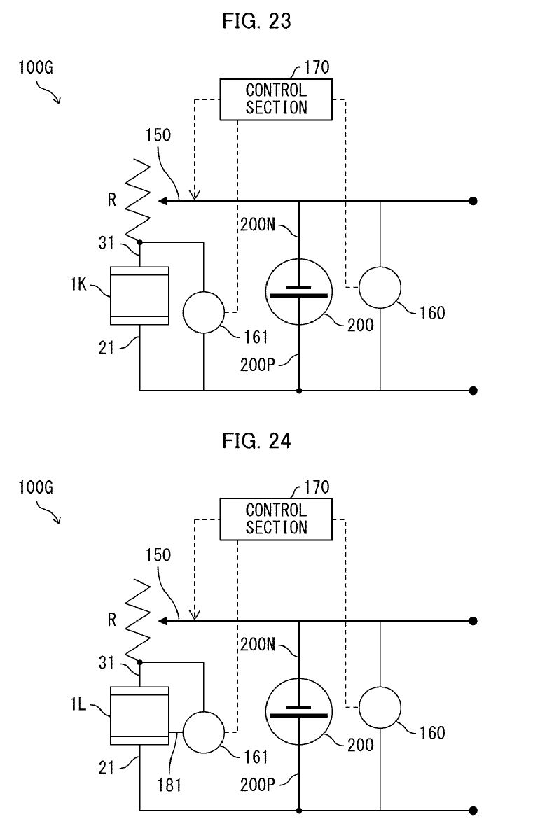

The following description will discuss another embodiment of the present invention with reference to FIGS. 23 to 26. It should be noted that features of Embodiment 16 other than those described in Embodiment 16 are the same as those of Embodiments 1 to 15. For convenience, members having functions identical to those illustrated in the drawings of Embodiments 1 to 15 are assigned identical referential numerals and their descriptions are omitted.

It has been known that, for microorganisms for use in a microbial fuel cell, their activity can be controlled by controlling voltage applied across the electrodes. However, there has been no system that enables such control of the activity of microorganisms by use of natural energy in the natural environment without using a power source or the like that externally supplies electricity.

Embodiment 16 was made in view of the above issue, and an object thereof is to provide a microbial fuel cell system that is capable of controlling the activity of microorganisms using natural energy in the natural environment.

FIG. 23 schematically illustrates a microbial fuel cell system 100G of Embodiment 16. As illustrated in FIG. 23, the microbial fuel cell system 100G is different from the microbial fuel cell system 100E shown in FIG. 21 in that the microbial fuel cell system 100G is configured such that, in a state in which a solar cell 200 receives light and photoelectromotive force is confirmed, a positive electrode 200P of the solar cell 200 and an anode wire 21 of a microbial fuel cell 1K are electrically connected to each other, whereas a negative electrode 200N of the solar cell 200 and a cathode wire 31 of the microbial fuel cell 1K are electrically connected to each other.

The microbial fuel cell system 100G includes: a variable-resistance changeover switch 150 configured to connect between the solar cell 200 and the microbial fuel cell 1K and to adjust the resistance of a load R to be applied; an inter-terminal voltage sensing section 160 for the solar cell 200; and an inter-terminal voltage sensing section 161 for the microbial fuel cell 1K.

The microbial fuel cell system 100G further includes a control section 170. The control section 170 controls the resistance of the load R to which the variable-resistance changeover switch 150 is designed to connect. The control section 170 controls the resistance of the load R according to the voltage sensed by the inter-terminal voltage sensing section 160 for the solar cell 200 or according to the voltage sensed by the inter-terminal voltage sensing section 161 for the microbial fuel cell 1K so that the voltage across the terminals of the microbial fuel cell 1K is maintained at a desired value.

In the state in which photoelectromotive force of the solar cell 200 is confirmed, the voltage generated at the solar cell 200 is partially applied across the electrodes of the microbial fuel cell 1K such that the positive electrode 200P is connected to the anode wire 21 and the negative electrode 200N is connected to the cathode wire 31. This makes it possible to activate the metabolic cycle of microorganisms in the vicinity of the anode 20 of the microbial fuel cell.

With the above configuration, in a case where, for instance, a target to be decomposed such as wet waste or sludge is introduced in a fuel chamber 3, the microbial fuel cell 1K can function as a refuse decomposer or a sludge decomposer. According to the configuration of the microbial fuel cell system 100G of Embodiment 16, the activity of the microorganisms in the vicinity of the anode 20 is enhanced by the electromotive force of the solar cell 200, and thereby the speed of the process by the microbial fuel cell 1K can be increased. An object of Embodiment 16 is to enhance the activity of the microorganisms in the vicinity of the anode 20, and thus drawing of the electromotive force from the microbial fuel cell 1K is not essential. For example, the following connection may be employed: the electromotive force of the microbial fuel cell 1K is consumed as Joule's heat at the load R connected to the microbial fuel cell 1K.

Meanwhile, it is known that there is a voltage range suitable for selective collection of a desired microorganism at the anode 20. The variable-resistance changeover switch 150 is capable of controlling the voltage applied across the terminals of the microbial fuel cell 1K to be a desired voltage falling within the suitable voltage range. For instance, it is possible to set a voltage for enhancing the activity of a microorganism suitable for decomposing wet waste, sludge, and/or the like. Furthermore, the use of the solar cell 200 makes it possible to operate this activity-enhancing system while providing freedom from maintenance.

This makes it possible to provide a microbial fuel cell system 100G that can control the activity of microorganisms using energy from sunlight in the natural environment.

The solar cell 200 and the microbial fuel cell 1K of Embodiment 16 may be positioned relative to each other as illustrated in FIG. 22.

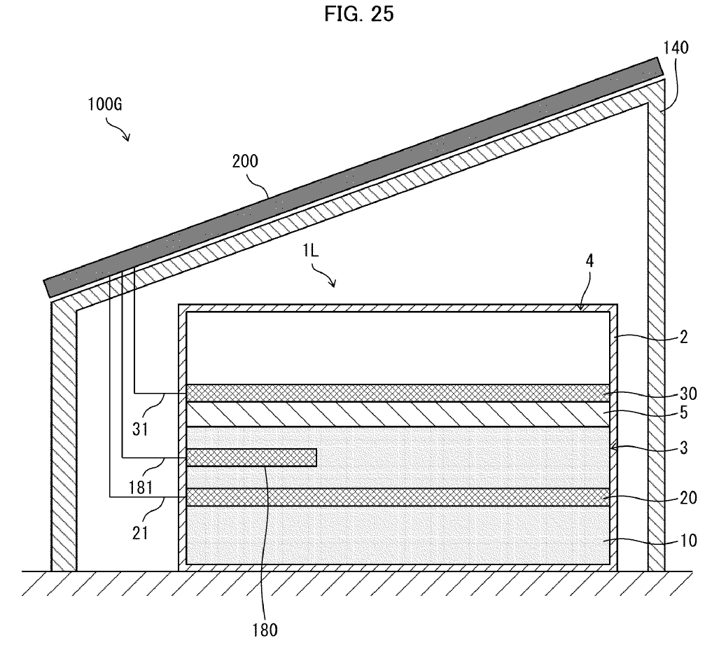

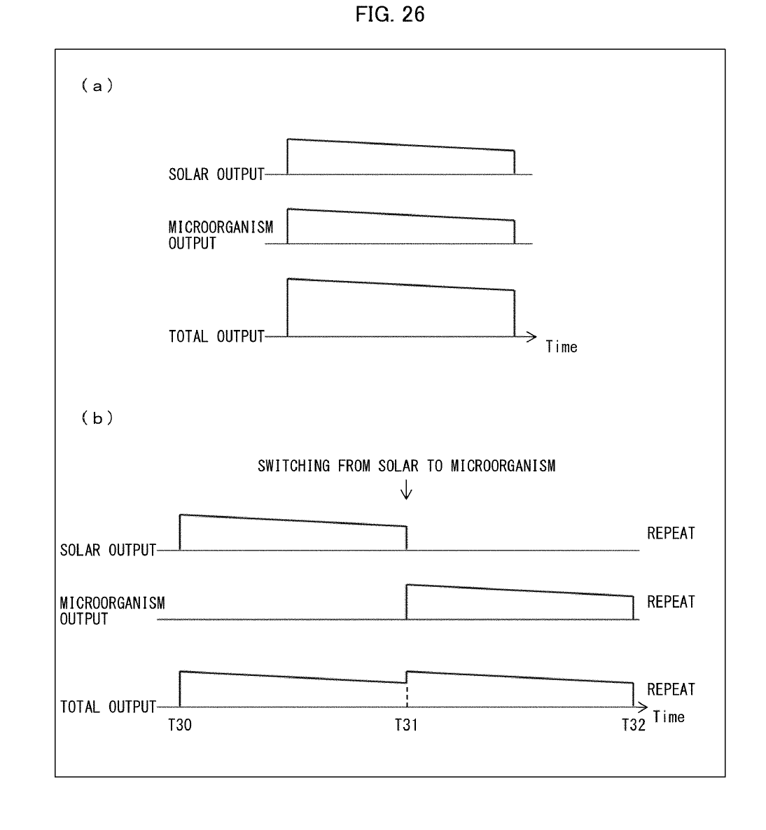

The microbial fuel cell system 100G of Embodiment 16 may be arranged as described below. The arrangement is described with reference to FIGS. 24 and 25. FIG. 24 schematically illustrates another example of the microbial fuel cell system 100G of Embodiment 16. FIG. 25 is a longitudinal cross-sectional view schematically illustrating a configuration of the microbial fuel cell system 100G.

Specifically, as illustrated in FIG. 24, the microbial fuel cell system 100G includes a microbial fuel cell 1L in place of the microbial fuel cell 1K, and a reference electrode wire 181 extends from the microbial fuel cell 1L. An inter-terminal voltage sensing section 161 is connected to the reference electrode wire 181 and a cathode wire 31.

The control section 170 controls the resistance of a load R, to which a variable-resistance changeover switch 150 is connected, according to the voltage sensed by the inter-terminal voltage sensing section 161 so that the voltage across the terminals of the reference electrode wire 181 and the cathode wire 31 of the microbial fuel cell 1L is maintained at a desired value.

As illustrated in FIG. 25, the microbial fuel cell 1L has a reference electrode 180 in a fuel chamber 3. The reference electrode 180 is electrically connected to the reference electrode wire 181, which passes through a housing 2 and extends to outside the microbial fuel cell 1L.

This makes it possible to apply, by using the reference electrode 180 as a reference, a voltage suitable for selective collection of a desired microorganism at the anode 20.

The solar cell 200 and the microbial fuel cell 1K of Embodiment 16 may be arranged such that modes can be switched over with respect to parallel connection as illustrated in FIG. 21. Specifically, assuming that a state in which the positive electrode 200P and the negative electrode 200N of the solar cell 200 are arranged in the direction as illustrated in FIG. 23 (i.e., the positive electrode 200P is connected to the anode wire 21) is an activity-enhancing mode and that a state in which the positive electrode 200P and the negative electrode 200N of the solar cell 200 are arranged in the direction as illustrated in FIG. 21 (i.e., negative electrode 200N is connected to the anode wire 21) is an electricity-generating mode, the microbial fuel cell system 100G may be configured to be switchable between the activity-enhancing mode and the electricity-generating mode. This arrangement can be realized by, for example, a mechanism that can reverse the direction of connection of the solar cell 200.

This makes it possible to achieve a microbial fuel cell system 100G by which: the activity of a microorganism in the vicinity of the anode 20 is enhanced by the solar cell 200 in the activity-enhancing mode (i.e., electricity generation efficiency is improved); and thereafter the mode is switched to the electricity-generating mode in which the electromotive forces of the solar cell 200 and the microbial fuel cell 1K can be supplied to the outside.

The electricity output of the microbial fuel cell system 100G in the electricity-generating mode is described with reference to FIG. 26. FIG. 26 is a graph schematically illustrating how the output voltage changes at points in time in which the microbial fuel cell 1K and the solar cell 200 operate when the microbial fuel cell system 100G is in the electricity-generating mode.

As illustrated in (a) of FIG. 26, in a case where the microbial fuel cell 1K and the solar cell 200 are electrically connected in parallel with each other, the combination of the microbial fuel cell 1K and the solar cell 200 provides a large output as a whole. However, the total output voltage decreases with time.

Meanwhile, the microbial fuel cell system 100G may be arranged such that, as illustrated in FIG. 21, in the electricity-generating mode, the microbial fuel cell system 100G includes a changeover switch 110 which enables switching between a state in which the microbial fuel cell 1K supplies electricity to the load 120 and a state in which the solar cell 200 supplies electricity to the load 120.

In this case, by carrying out the electricity generation by selectively using the microbial fuel cell 1K and the solar cell 200 as illustrated in (b) of FIG. 26, it is possible to generate electricity stably for a long period of time.

For instance, the following arrangement can be employed: the connection is made such that only the solar cell 200 outputs electricity during a period from time T30 to time T31; the connection is changed from the solar cell 200 to the microbial fuel cell 1K at time T31 by which the output of the solar cell 200 has decreased to a certain extent; and the connection is changed from the microbial fuel cell 1K to the solar cell 200 at time T32 by which the output of the microbial fuel cell 1K has decreased to a certain extent.

With this arrangement, the microbial fuel cell system 100G is capable of controlling the activity of a microorganism using energy from sunlight in the natural environment and also capable of stably supplying electricity.

### [Recap]

A microbial fuel cell 1A of Aspect 1 of the present invention includes: a housing 2 that defines a closed space isolated from an external environment; an electrolyte layer with proton conductivity (ion-conductive layer 5), the electrolyte layer dividing the closed space into a fuel chamber 3 and an air chamber 4, the fuel chamber 3 being configured to have therein a microorganism-containing substance 10, the microorganism-containing substance 10 containing an exoelectrogen 11, an aerobic bacterium 13, and a fuel substance 12, the air chamber 4 containing oxygen therein; a negative electrode (anode 20) that is disposed in the fuel chamber 3 and that is configured to receive an electron produced by decomposition, by the exoelectrogen 11, of organic matter in the fuel substance 12; and a positive electrode (cathode 30) that is disposed in the air chamber 4 so as to be in contact with the electrolyte layer (ion-conductive layer 5) and that is configured to donate an electron to oxygen, the housing 2 having, in at least part thereof, a hole 6 through which the external environment and the fuel chamber 3 are in communication with each other, the housing 2 being provided with an openable/closeable member 7 configured to be able to open and close the hole 6.

According to the above configuration, while the openable/closeable member is in the open state, the microorganism-containing substance can be supplied into the fuel chamber through the hole. Furthermore, the fuel chamber can be hermetically closed with the openable/closeable member. Moreover, oxygen inside the fuel chamber is consumed by the aerobic bacterium, and the aerobic bacterium releases a gas other than oxygen. This makes it possible to lower the oxygen concentration of the microorganism-containing substance.

As a result, an environment suitable for the anaerobic exoelectrogen is created, the activity of the exoelectrogen is enhanced, and thus a microbial fuel cell capable of highly efficiently generating electricity can be obtained.

Furthermore, since there is no need to provide a fuel sending mechanism such as a pump, it is possible to make a low-cost microbial fuel cell that gives a large net generation, and this microbial fuel cell has relatively less limitation on its conditions of use such as a place of installation. Furthermore, it is not necessary to prepare a microorganism-containing substance having a low oxygen concentration in advance. Therefore, it is possible to install a sensor or the like, which is driven by electricity supplied from the microbial fuel cell, with reasonable installation cost even in locations where an electricity supply is difficult to obtain.

As such, it is possible to provide a microbial fuel cell which is capable of stably generating electricity and in which a pump or the like for fuel supply is not necessary and low oxygen concentration is maintained in the vicinity of a fuel electrode.

A microbial fuel cell 1A of Aspect 2 of the present invention is preferably a microbial fuel cell obtained by arranging Aspect 1 such that, while the microbial fuel cell 1A is generating electricity, the hole 6 is in a closed state in which the hole 6 is closed with the openable/closable member 7.

The above configuration makes it possible to prevent, during electricity generation, oxygen from entering the fuel chamber 3 from the external environment.

A microbial fuel cell 1A of Aspect 3 of the present invention can be a microbial fuel cell obtained by arranging Aspect 1 or 2 such that the microorganism-containing substance 10 further contains an anaerobic bacterium 14, the anaerobic bacterium 14 being a bacterium that, during its metabolism, consumes oxygen or produces a gas other than oxygen.

According to the above configuration, the anaerobic bacterium consumes oxygen in the microorganism-containing substance or produces a gas other than oxygen. Therefore, it is possible to lower the oxygen concentration in the microorganism-containing substance to a greater extent.

A microbial fuel cell 1A of Aspect 4 of the present invention may be a microbial fuel cell obtained by arranging Aspect 3 such that the anaerobic bacterium 14 is a methanogen.

According to the above configuration, the methanogen produces methane and carbon dioxide from organic matter in the microorganism-containing substance. Therefore, it is possible to lower the oxygen concentration in the microorganism-containing substance to a greater extent.

A microbial fuel cell 1C or 1D of Aspect 5 of the present invention is preferably the microbial fuel cell of any of Aspects 1 to 4 that further includes at least one of: a fuel timely-releasing mechanism (fuel timely-releasing member 60) configured to release a supplemental fuel substance into the fuel chamber 3 in a timed manner; and an oxygen timely-releasing mechanism (oxygen timely-releasing member 61) configured to release oxygen into the air chamber 4 in a timed manner.

According to the above configuration, it is possible to carry out at least one of: addition of a fuel to the fuel chamber; and addition of oxygen to the air chamber. Therefore, it is possible to configure a microbial fuel cell that is free from maintenance for a long period of time. The result is that the microbial fuel cell is a long-life microbial fuel cell.

A microbial fuel cell 1B of Aspect 6 of the present invention can be a microbial fuel cell obtained by arranging any of Aspects 1 to 5 such that: the housing 2 is constituted by a first housing 2a having a first opening 52 and a second housing 2b having a second opening 53, the housing 2 being obtained by inserting the second housing 2b into the first opening 52 of the first housing 2a such that one end of the second housing 2b is inserted first, the one end being an end at which the second opening 53 is situated; the first housing 2a has a space therein and the second housing 2b has a space therein, the space inside the first housing 2a and the space inside the second housing 2b being isolated from the external environment except for the first opening 52 and the second opening 53, respectively; the space inside the first housing 2a serves as the fuel chamber 3; the second housing 2b has therein the negative electrode (anode 20), the electrolyte layer (ion-conductive layer 5), the positive electrode (cathode 30), and the air chamber 4 which are arranged in this order from the second opening 53; in the first opening 52, an area formed between the first housing 2a and the second housing 2b serves as the hole 50; and the openable/closeable member 51 is provided so as to protrude from an outer surface of the second housing 2b.

According the above configuration, it possible to replace the negative electrode, the electrolyte layer, and the positive electrode all at once by replacing the second housing, and therefore the microbial fuel cell is easy to maintain.

A microbial fuel cell 1A or 1I of Aspect 7 of the present invention is preferably a microbial fuel cell obtained by arranging any of Aspects 1 to 6 such that a wall that defines the air chamber 4 has, in at least part thereof, an air intake hole 70 through which the air chamber 4 and an external environment outside the air chamber 4 are in communication with each other.

According to the above configuration, it is possible to supply oxygen from the external environment outside the air chamber to the air chamber through the air intake hole. Therefore, it is possible to prevent lack of oxygen in the air chamber and to thereby achieve a microbial fuel cell that is free from maintenance for a long period of time. The result is that the microbial fuel cell is a long-life microbial fuel cell.

A microbial fuel cell 1I of Aspect 8 of the present invention is preferably the microbial fuel cell of Aspect 7 that further includes an air intake openable/closeable member 72 that is configured to be able to open and close the air intake hole 70.

According to the above configuration, in a case where, for instance, the microbial fuel cell is used in such a situation that the external environment is a liquid, the air intake openable/closeable member in the closed state prevents the liquid from entering the air chamber from the external environment through the air intake hole.

When the air intake openable/closeable member is brought into the open state in a condition in which the external environment outside the air chamber is air, oxygen can be supplied into the air chamber.

As such, it is possible to achieve a microbial fuel cell that has relatively less limitation on its conditions of use and that is usable over a long period of time.

A microbial fuel cell 1I of Aspect 9 of the present invention is preferably the microbial fuel cell of Aspect 8 that further includes an air intake pipe 71 connected to the air intake hole 70, the air intake pipe 71 being provided with the air intake openable/closeable member 72.

According to the above configuration, when, for instance, the microbial fuel cell is used in such a situation that the external environment is a liquid, the air intake openable/closeable member in the closed state hermetically closes the air chamber. In a condition in which the external environment of the microbial fuel cell is a liquid, by exposing an end of the air intake pipe to ambient air and bringing the air intake openable/closeable member into the open state, it is possible to supply oxygen into the air chamber.

As such, the microbial fuel cell is easy to use inside a fuel solution that contains the microorganism-containing substance. It is possible to achieve a microbial fuel cell that has lesser limitation on its conditions of use and that is usable over a long period of time.

A microbial fuel cell 1E of Aspect 10 of the present invention is preferably a microbial fuel cell obtained by arranging any of Aspects 1 to 9 such that: the housing 2 further has a stirring chamber (crush stirring chamber 62) that includes a stirrer 62a configured to stir the microorganism-containing substance 10, the stirring chamber (crush stirring chamber 62) lying between the external environment and the fuel chamber 3; the hole 6 is situated on the stirring chamber (crush stirring chamber 62).

According to the above configuration, it is possible to crush, with the stirrer of the stirring chamber, organic matter such as wet waste to make it into a fuel substance that is easily useful as a fuel. The fuel substance can be supplied into the fuel chamber as the microorganism-containing substance. This makes it possible to use various kinds of organic matter as fuels.

The crush stirring chamber also functions to cause convection of nutrients by causing stirring inside the fuel chamber. When the microorganism-containing substance is convected, the microorganism-containing substance metabolizes more efficiently and thereby improves electricity generation efficiency.

A microbial fuel cell 1F of Aspect 11 of the present invention is preferably the microbial fuel cell of any of Aspects 1 to 10 that further includes a second layer (filter layer 64) disposed in the fuel chamber 3 so as to be in contact with the electrolyte layer (ion-conductive layer 5).

According to the above configuration, the second layer serves to prevent the electrolyte layer from being contaminated by the microorganism-containing substance. This makes it possible to keep the electrolyte layer clean for a long period of time even in a case where the microorganism-containing substance, which contains various substances, is used as the fuel solution, and thus possible to configure a microbial fuel cell that generates electricity stably for a long period of time.

A microbial fuel cell 1G of Aspect 12 of the present invention is preferably the microbial fuel cell of any of Aspects 1 to 11 that further includes a third layer (anode filter layer 65) disposed in contact with the negative electrode (anode 20) so as to be closer to the hole 6 than the negative electrode (anode 20) is to the hole 6.

According to the above configuration, the third layer serves to prevent the negative electrode from being clogged with the microorganism-containing substance. This makes it possible to prevent the negative electrode from being clogged even in a case where the microorganism-containing substance, which contains various substances, is used as the fuel solution, and thus possible to configure a microbial fuel cell that generates electricity stably for a long period of time.

A microbial fuel cell 1H of Aspect 13 of the present invention is preferably a microbial fuel cell obtained by arranging any of Aspects 1 to 12 such that the housing 2 is covered with a heat insulator.

According to the above configuration, it is possible to prevent moisture in the microorganism-containing substance from freezing under the effect of weather in the external environment of the microbial fuel cell.

A microbial fuel cell 1H of Aspect 14 of the present invention may be a microbial fuel cell obtained by arranging any of Aspects 1 to 13 such that the microorganism-containing substance contains water and an antifreeze (freezing point depressant 67) to lower a freezing point of water.

According to the above configuration, it is possible to prevent, to a greater extent, moisture from freezing under the effect of the outside atmosphere.

A microbial fuel cell 1A of Aspect 15 of the present invention can be a microbial fuel cell obtained by arranging any of Aspects 1 to 14 such that: the openable/closeable member 7 includes a supporting member (spacer 43) configured to keep the hole 6 in an open state, the supporting member (spacer 43) being made of a material that is soluble in a specific external environment; and the openable/closeable member 7 is brought into a closed state by dissolution of the supporting member (spacer 43).

According to the above configuration, the following arrangement is available: in a case where the microbial fuel cell is soaked in a certain external environment, substances of the external environment are allowed to enter the fuel chamber and thereafter the supporting member dissolves with a time lag, resulting in hermetical closing of the hole. This makes it possible to automatically close the fuel chamber hermetically after the microbial fuel cell is soaked in a certain external environment and a fuel is supplied into the fuel cell. As a result, a user does not need to operate the openable/closeable member, and the microbial fuel cell becomes more convenient.

A microbial fuel cell 1A of Aspect 16 of the present invention may be a microbial fuel cell obtained by arranging any of Aspects 1 to 15 such that the housing 2 is made of a biodegradable material.

According to the above configuration, it is not necessary to collect unneeded microbial fuel cells, and the microbial fuel cell can be used as a disposable cell.

A microbial fuel cell system 100A of Aspect 17 of the present invention includes: the microbial fuel cell 1I of any one of Aspects 1 to 16; and a sensor 80 configured to be driven by an electromotive force of the microbial fuel cell 1I, the microbial fuel cell 1I and the sensor 80 being disposed inside a fuel substance bath (microorganism mixture bath 73) that contains the microorganism-containing substance 10, the openable/closeable member 7 of the microbial fuel cell 1I being configured to be in a closed state while the sensor 80 is analyzing a state of the fuel substance bath (microorganism mixture bath 73).

According to the above configuration, since the openable/closeable member is in the closed state while electricity is supplied to the sensor, the sensor can be driven while preventing electrochemical short-circuits between the fuel substance bath and the microorganism-containing substance.

Therefore, a microbial fuel cell system 100A of Aspect 18 of the present invention may be a microbial fuel cell system obtained by arranging Aspect 17 such that the fuel substance bath is an aeration tank surrounded by a reaction treatment tank.

According to the above configuration, the aeration tank is provided with a mechanism of supplying oxygen in order to enhance the activity of aerobic bacteria. However, since the microbial fuel cell 1I is capable of lowering the oxygen concentration in the fuel chamber, electricity generation is available even in a case where the external environment is an aeration tank.

A microbial fuel cell system 100B of Aspect 19 of the present invention includes: a plurality of the microbial fuel cells 1J of any of Aspects 1 to 16; and a fuel pipe 93 that is configured to carry the microorganism-containing substance 10 and that is connected to the holes 6 of the respective plurality of microbial fuel cells 1J, the plurality of microbial fuel cells 1J being electrically connected in series with each other, electrically connected in parallel with each other, or electrically connected in series and parallel with each other.

According to the above configuration which includes the fuel pipe, it is possible to fill the microorganism-containing substance in the fuel chambers of the respective microbial fuel cells at once. In addition, it is possible to hermetically close the fuel chambers of the respective microbial fuel cells with the openable/closeable members. Therefore, it is possible to prevent oxygen from entering the fuel chambers, and also possible to avoid short-circuits between fuel chambers.

As such, with a plurality of microbial fuel cells electrically connected to each other, the microbial fuel cell system is capable of generating large power outputs.

A microbial fuel cell system 100C or 100D of Aspect 20 of the present invention includes: a plurality of individual electric feeder sections (microbial fuel cells 1K) that include microbial fuel cell units U1 to U3; an output sensing section 121 configured to sense an output from each of the plurality of electric feeder sections (microbial fuel cells 1K); and an output switching section (control section 130) configured to connect an output circuit to a selected one of the plurality of electric feeder sections (microbial fuel cells 1K), wherein the selected one of the plurality of electric feeder sections, which is connected to the output circuit by the output switching section (changeover switch 110), is an electric feeder section whose output sensed by the output sensing section 121 is equal to or greater than a predetermined value.

According to the above configuration, an electric feeder section whose output is equal to or greater than a predetermined value is selected by the output switching section and this selected electric feeder section is connected to the output circuit. The microbial fuel cells here have similar characteristics to capacitors. Specifically, while the microbial fuel cells are not connected to the circuitry, the microbial fuel cells can be charged with electricity by a microbiological electric generation cycle. Therefore, in a case where the electric feeder sections are selectively connected to the circuitry, each electric feeder section repeatedly undergoes a discharging state and a charging state. As a result, it is possible to provide a microbial fuel cell system that is capable of constantly supplying a certain amount or more of electricity to a load stably for a long period of time by repeating this electricity generation cycle.

A microbial fuel cell system 100C or 100D of Aspect 21 of the present invention can be a microbial fuel cell system obtained by arranging Aspect 20 such that: in a case where the output of the selected one of the plurality of electric feeder sections (microbial fuel cells 1K), which is connected to the output circuit, has become lower than the predetermined value, the output switching section (control section 130) disconnects the output circuit from the selected one of the plurality of electric feeder sections (microbial fuel cells 1K) and connects the output circuit to another selected one of the plurality of electric feeder sections (microbial fuel cells 1K) whose output sensed by the output sensing section 121 is equal to or greater than the predetermined value.

According to the above configuration, the output from the microbial fuel cell system is prevented from becoming lower than a predetermined value and, in addition, an electric feeder section(s) other than the currently connected electric feeder section can be kept in the charging state for a certain amount of time. As such, the microbial fuel cells are easy to charge sufficiently.

A microbial fuel cell system 100C or 100D of Aspect 22 of the present invention can be a microbial fuel cell system obtained by arranging Aspect 20 or 21 such that, after the output circuit has been in connection with the selected one of the plurality of electric feeder sections (microbial fuel cells 1K) for a predetermined period of time, the output switching section (control section 130) disconnects the output circuit from the selected one of the plurality of electric feeder sections (microbial fuel cells 1K) and connects the output circuit to another selected one of the plurality of electric feeder sections (microbial fuel cells 1K) whose output sensed by the output sensing section 121 is equal to or greater than the predetermined value.

According to the above configuration, electric feeder sections can be switched before the output sensed by the output sensing section becomes lower than the predetermined value. This makes it possible to increase the average output of the microbial fuel cell system.

A microbial fuel cell system 100C or 100D of Aspect 23 of the present invention can be a microbial fuel cell system obtained by arranging any of Aspects 20 to 22 such that the output switching section (control section 130) selects two or more of the electric feeder sections (microbial fuel cells 1K), connects the output circuit to the selected two or more of the electric feeder sections (microbial fuel cells 1K), and, when disconnecting the output circuit from one or more of the two or more of the electric feeder sections (microbial fuel cells 1K) and connecting the output circuit to another electric feeder section(s) (microbial fuel cell(s) 1K), the output switching section (control section 130) keeps the other(s) of the two or more of the electric feeder sections (microbial fuel cells 1K) in connection with the output circuit.

According to the above configuration, when the connection of the output circuit to the electric feeder sections is changed, one or more of the electric feeder sections are kept in connection with the output circuit. Therefore, the loss of electricity at a moment of switching is prevented. This makes it possible to stably operate the microbial fuel cell system.

A microbial fuel cell system 100D of Aspect 24 of the present invention can be a microbial fuel cell system obtained by arranging any of Aspects 20 to 23 such that the microbial fuel cell units U1 to U3 are a plurality of microbial fuel battery cells (microbial fuel cells 1K) connected in series and/or parallel.

According to the above configuration, it is possible to achieve a high-power (high-voltage or high-current) microbial fuel cell system without necessitating complex control.

A microbial fuel cell system 100E of Aspect 25 of the present invention can be a microbial fuel cell system obtained by arranging any of Aspects 20 to 23 such that at least one of the electric feeder sections (microbial fuel cells 1K) includes a photoelectric transducer (solar cell 200).

According to the above configuration, the microbial fuel cell system is such that: under a condition in which electricity generation by the photoelectric transducer is not available, the electric feeder sections other than the photoelectric transducer can supply electricity; whereas, under a condition in which the electricity generation by the photoelectric transducer is available, the electric feeder sections other than the photoelectric transducer can be charged with electricity. This makes it possible to stably supply electricity at any time of day or night in all weathers.

A microbial fuel cell system 100F of Aspect 26 of the present invention is preferably a microbial fuel cell system obtained by arranging Aspect 25 such that the at least one of the electric feeder sections (microbial fuel cells 1K), which includes the photoelectric transducer (solar cell 200), is positioned above the other(s) of the electric feeder section(s).

According to the above configuration, since electric feeder section(s) is/are located under the roof, the electric feeder section(s) is/are not susceptible to the weather, such as direct sunlight, rain, and wind, and thus electricity generation can be carried out more stably. Furthermore, the space right below the photoelectric transducer, which has not been made effective use of, can be made use of by the other electric feeder section(s) to generate electricity.

This makes it possible to provide a microbial fuel cell system that makes effective use of land and thereby increases the amount of electricity generation per unit of area occupied by the system.

A microbial fuel cell system 100G of Aspect 27 of the present invention includes: a microbial fuel cell 1K and a photoelectric transducer (solar cell 200), wherein, in a state in which a photoelectromotive force of the photoelectric transducer (solar cell 200) is confirmed, a positive electrode of the photoelectric transducer (solar cell 200) and a negative electrode of the microbial fuel cell 1K are electrically connected to each other whereas a negative electrode of the photoelectric transducer (solar cell 200) and a positive electrode of the microbial fuel cell 1K are electrically connected to each other.

According to the above configuration, the voltage generated at the photoelectric transducer is partially applied across the electrodes of the microbial fuel cell and thereby the metabolic cycle of the microorganism in the vicinity of the anode of the microbial fuel cell is activated.

This makes it possible to provide a microbial fuel cell system that can control the activity of microorganisms using energy from sunlight in the natural environment.

A microbial fuel cell system 100G of Aspect 28 of the present invention can be the microbial fuel cell system of Aspect 27 that further includes: a variable resistance (load R); and a control section 170 configured to control the value of the variable resistance (load R) such that the voltage across a negative electrode and a positive electrode of the microbial fuel cell 1K falls within a predetermined range, the variable resistance (load R) being connected between a positive electrode of the photoelectric transducer (solar cell 200) and the negative electrode of the microbial fuel cell 1K or between a negative electrode of the photoelectric transducer (solar cell 200) and the positive electrode of the microbial fuel cell 1K.

It is known that there is a voltage range suitable for selective collection of a desired microorganism at the anode. According to the above configuration, the control section 170 is capable of controlling the voltage applied across the terminals of the microbial fuel cell to be a desired voltage falling within the suitable voltage range. Therefore, it is possible to set a voltage for enhancing the activity of a microorganism suitable for decomposing, for example, wet waste, sludge, and/or the like.

A microbial fuel cell system 100G of Aspect 29 of the present invention can be a microbial fuel cell system obtained by arranging Aspect 27 such that the microbial fuel cell 1L further includes a reference electrode 180 disposed inside a fuel chamber 3 that has an exoelectrogen 11 and a fuel substance 12 therein, and that the microbial fuel cell system includes: a variable resistance (load R); and a control section 170 configured to control the value of the variable resistance (load R) such that the voltage across a positive electrode and the reference electrode 180 of the microbial fuel cell 1K falls within a predetermined range, the variable resistance (load R) being connected between a positive electrode of the photoelectric transducer and a negative electrode of the microbial fuel cell or between a negative electrode of the photoelectric transducer and the positive electrode of the microbial fuel cell.

According to the above configuration, the control section is capable of controlling the value of the variable resistance, by using the reference electrode as a reference, so as to apply a voltage suitable for selective collection of a desired microorganism at the anode.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1A to 1L Microbial fuel cell (Electric feeder section)

2 Housing

2a First housing

2b Second housing

3 Fuel chamber

4 Air chamber

5 Ion-conductive layer (Electrolyte layer)

6, 50 Hole

7, 51, 92 Openable/closeable member

10 Microorganism-containing substance

11 Exoelectrogen

12 Fuel substance

13 Aerobic bacterium

14 Anaerobic bacterium

20 Anode (Negative electrode)

30 Cathode (Positive electrode)

43 Spacer (Supporting member)

52 First opening

53 Second opening

60 Fuel timely-releasing member (Fuel timely-releasing mechanism)

61 Oxygen timely-releasing member (Oxygen timely-releasing mechanism)

62 Crush stirring chamber (Stirring chamber)

62a Stirrer

64 Filter layer (Second layer)

65 Anode filter layer (Third layer)

66 Cover (Heat insulator)

67 Freezing point depressant (Antifreeze)

70 Air intake hole

71 Air intake pipe

72 Air intake openable/closeable member

73 Microorganism mixture bath (Fuel substance bath)

80 Sensor 93 Fuel pipe

100A to 100G Microbial fuel cell system

121 Output sensing section

130 Control section (output switching section)

170 Control section

200 Solar cell (photoelectric transducer)

R Load (Variable resistance)

U1 to U3 Microbial fuel cell unit (Electric feeder section)

1. A microbial fuel cell comprising:
a housing that defines a closed space isolated from an external environment;
an electrolyte layer with proton conductivity, the electrolyte layer dividing the closed space into a fuel chamber and an air chamber, the fuel chamber being configured to have therein a microorganism-containing substance, the microorganism-containing substance containing an exoelectrogen, an aerobic bacterium, and a fuel substance, the air chamber having oxygen therein;
a negative electrode that is disposed in the fuel chamber and that is configured to receive an electron produced by decomposition, by the exoelectrogen, of organic matter in the fuel substance; and
a positive electrode that is disposed in the air chamber so as to be in contact with the electrolyte layer and that is configured to donate an electron to oxygen,
the housing having, in at least part thereof, a hole through which the external environment and the fuel chamber are in communication with each other,
the housing being provided with an openable/closeable member configured to be able to open and close the hole.

2. The microbial fuel cell according to claim 1, wherein, while the microbial fuel cell is generating electricity, the hole is in a closed state in which the hole is closed with the openable/closable member.

3. The microbial fuel cell according to claim 1, wherein:
the microorganism-containing substance further contains an anaerobic bacterium, the anaerobic bacterium being a bacterium that, during its metabolism, consumes oxygen or produces a gas other than oxygen.

4. The microbial fuel cell according to claim 3, wherein the anaerobic bacterium is a methanogen.

5. The microbial fuel cell according to claim 1, further comprising at least one of:
a fuel timely-releasing mechanism configured to release a supplemental fuel substance into the fuel chamber in a timed manner; and
an oxygen timely-releasing mechanism configured to release oxygen into the air chamber in a timed manner.

6. The microbial fuel cell according to claim 1, wherein:
the housing is constituted by a first housing having a first opening and a second housing having a second opening, the housing being obtained by inserting the second housing into the first opening of the first housing such that one end of the second housing is inserted first, the one end being an end at which the second opening is situated;
the first housing has a space therein and the second housing has a space therein, the space inside the first housing and the space inside the second housing being isolated from the external environment except for the first opening and the second opening, respectively;
the space inside the first housing serves as the fuel chamber;
the second housing has therein the negative electrode, the electrolyte layer, the positive electrode, and the air chamber which are arranged in this order from the second opening;
in the first opening, an area formed between the first housing and the second housing serves as the hole; and
the openable/closeable member is provided so as to protrude from an outer surface of the second housing.

7. The microbial fuel cell according to claim 1, wherein a wall that defines the air chamber has, in at least part thereof, an air intake hole through which the air chamber and an external environment outside the air chamber are in communication with each other.

8. The microbial fuel cell according to claim 7, further comprising an air intake openable/closeable member that is configured to be able to open and close the air intake hole.

9. The microbial fuel cell according to claim 8, further comprising an air intake pipe connected to the air intake hole,
the air intake pipe being provided with the air intake openable/closeable member.

10. The microbial fuel cell according to claim 1, wherein:
the housing further has a stirring chamber that includes a stirrer configured to stir the microorganism-containing substance, the stirring chamber lying between the external environment and the fuel chamber; and
the hole is situated on the stirring chamber.

11. The microbial fuel cell according to claim 1, further comprising a second layer disposed in the fuel chamber so as to be in contact with the electrolyte layer.

12. The microbial fuel cell according to claim 1, further comprising a third layer disposed in contact with the negative electrode so as to be closer to the hole than the negative electrode is to the hole.

13. The microbial fuel cell according to claim 1, wherein the housing is covered with a heat insulator.

14. The microbial fuel cell according to claim 1, wherein the microorganism-containing substance contains water and an antifreeze to lower a freezing point of water.

15. The microbial fuel cell according to claim 1, wherein:
the openable/closeable member includes a supporting member configured to keep the hole in an open state, the supporting member being made of a material that is soluble in a specific external environment; and
the openable/closeable member is brought into a closed state by dissolution of the supporting member.

16. The microbial fuel cell according to claim 1, wherein the housing is made of a biodegradable material.

17. A microbial fuel cell system comprising:
the microbial fuel cell recited in claim 1; and
a sensor configured to be driven by an electromotive force of the microbial fuel cell,
the microbial fuel cell and the sensor being situated inside a fuel substance bath that contains the microorganism-containing substance,
the openable/closeable member of the microbial fuel cell being configured to be in a closed state while the sensor is analyzing a state of the fuel substance bath.

18. The microbial fuel cell system according to claim 17, wherein the fuel substance bath is an aeration tank surrounded by a reaction treatment tank.

19. A microbial fuel cell system comprising:
a plurality of the microbial fuel cells recited in claim 1; and
a fuel pipe that is configured to carry the microorganism-containing substance and that is connected to the holes of the respective plurality of microbial fuel cells,
the plurality of microbial fuel cells being electrically connected in series with each other, electrically connected in parallel with each other, or electrically connected in series and parallel with each other.
